(19) United States
(12) Patent Application Publication
(10) Pub. No.: US 2026/0297833 A1
(43) Pub. Date: Oct. 1, 2026

(54) LAUNDRY APPLIANCE WITH REMOVABLE BASKET ASSEMBLY

(71) Applicant: WHIRLPOOL CORPORATION, BENTON HARBOR, MI (US)

(72) Inventors: Andre L. Calderaro, Cordeirópolis (BR); Afrânio B. Chinchilha, Rio Claro (BR); Anthony J. Chupp, Kalamazoo, MI (US); Marco A. Curti Espinosa, Garcia, MI (US); Casey L. McCuan, Saugatuck, MI (US); Sergio Moreno Liñán, Apodaca (MX); John G. Opfer, Kalamazoo, MI (US); Jun Young Park, South Bend, IN (US); Jonathan D. Pugh, Benton Harbor, MI (US); Giovanni A. Roberto, Stevensville, MI (US); Avery J. Saylor, St. Joseph, MI (US); James O. Thompson, III, Stevensville, MI (US); Arthur V. Tosini, São Paulo (BR); Alexandre H. dos Santos, São Carlos (BR); Alexandre L. Marangoni, Rio Claro (BR); Kushagra Tiwari, Pune (IN); Fábio Libertini, Mogi Mirim (BR); Eric W. Merrow, Benton Harbor, MI (US)

(73) Assignee: WHIRLPOOL CORPORATION, BENTON HARBOR, MI (US)

(21) Appl. No.: 19/417,573

(22) Filed: Dec. 12, 2025

Related U.S. Application Data
(63) Continuation-in-part of application No. 19/092,077, filed on Mar. 27, 2025.

(51) Int. Cl. D06F 37/16; D06F 23/04; F16B 7/04

(52) U.S. Cl. CPC D06F 37/16; D06F 23/04; F16B 7/0406

(57) ABSTRACT

A laundry appliance includes a cabinet and a drum. An impeller is operably coupled with a closed end of the drum and includes a receiver. A basket assembly is selectively couplable with the impeller to separate an interior of the drum into an outer compartment between the drum and the basket assembly and an inner compartment within the basket assembly. The basket assembly includes an outer basket and an inner basket. A connector is configured to be positioned in the receiver. A locking feature is operably coupled with the connector and configured to adjust between a retracted position and a deployed position engaging the impeller. A skirt is coupled to the outer basket and is configured to be positioned over the impeller. The outer basket and the inner basket are configured to rotate about a rotational axis and separate from the skirt.

### CROSS-REFERENCE TO RELATED APPLICATION

This application is a continuation-in-part of and claims priority to U.S. patent application Ser. No. 19/092,077, filed on Mar. 27, 2025, entitled “LAUNDRY APPLIANCE WITH REMOVABLE BASKET ASSEMBLY,” the disclosure of which is hereby incorporated herein by reference in its entirety.

### BACKGROUND OF THE DISCLOSURE

The present disclosure generally relates to a laundry appliance with a removable basket assembly, and more specifically, to a laundry appliance with an impeller and an interior removable basket assembly selectively couplable to the impeller.

### SUMMARY OF THE DISCLOSURE

According to one aspect of the present disclosure, a laundry appliance includes a cabinet and a drum disposed within the cabinet and defining an interior. The drum has a drum opening opposite a closed end along a rotational axis. An impeller is operably coupled with the closed end of the drum. The impeller includes a receiver. A basket assembly is selectively couplable with the impeller to separate the interior of the drum into an outer compartment between the drum and the basket assembly and an inner compartment within the basket assembly. The basket assembly includes an outer basket and an inner basket disposed within the outer basket. The inner basket is movable within the outer basket along the rotational axis. A connector is configured to be positioned in the receiver. A locking feature is operably coupled with the connector and configured to adjust between a retracted position and a deployed position engaging the impeller. A skirt is coupled to the outer basket and is configured to be positioned over the impeller. The outer basket and the inner basket are configured to rotate about the rotational axis and relative to the skirt.

According to another aspect of the present disclosure, a laundry appliance includes a drum defining an interior. The drum has a drum opening opposite a closed end along a rotational axis. An impeller is operably coupled with the closed end of the drum. The impeller includes a receiver and protrusions proximate to the receiver. A basket assembly is selectively couplable with the impeller. The basket assembly includes an outer basket and an inner basket disposed within the outer basket. The inner basket is movable within the outer basket along the rotational axis. A connector is configured to be positioned in the receiver to couple the basket assembly with the impeller. A locking feature is operably coupled with the connector and operable between a retracted position and a deployed position. The deployed position is configured to lock the basket assembly to the impeller. A support member is disposed within the inner basket. Coupling members extend from the support member. A skirt is coupled to the outer basket and defines guide holes. The coupling members extend through the outer basket and through the guide holes of the skirt to engage the connector. The guide holes guide rotation of the outer basket and the inner basket as the outer basket and inner basket are rotated relative to the skirt and about the rotational axis between an initial insertion position and an installed position.

According to yet another aspect of the present disclosure, a basket assembly for a laundry appliance includes an outer basket and an inner basket disposed within the outer basket. The inner basket is movable within the outer basket along a rotational axis. A connector is configured to be positioned in an impeller receiver. The connector includes slots configured to receive protrusions of an impeller to couple the basket assembly with the impeller. A locking feature is operably coupled with the connector. The locking feature includes projections operable between a retracted position and a deployed position to lock the inner and outer baskets to the impeller. An engagement bracket is coupled to the connector. The engagement bracket includes tabs extending outwardly therefrom. A skirt is coupled to the outer basket and includes extensions proximate to the engagement bracket. The tabs are configured to slidably engage the extensions as the inner and outer baskets rotate relative to the skirt and about the rotational axis.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a laundry appliance, according to the present disclosure;

FIG. 2 is a partially exploded side perspective view of a drum with an interchangeable removable agitator and an interchangeable removable basket assembly, according to the present disclosure;

FIG. 3 is an exploded side perspective view of a removable basket assembly and an impeller, according to the present disclosure;

FIG. 4 is a side perspective view of a removable basket assembly for a laundry appliance, according to the present disclosure;

FIG. 5 is a front elevation view of a removable basket assembly for a laundry appliance, according to the present disclosure;

FIG. 6 is a side elevation view of a removable basket assembly for a laundry appliance, according to the present disclosure;

FIG. 7 is a top plan view of a removable basket assembly for a laundry appliance, according to the present disclosure;

FIG. 8 is a cross-sectional view of a removable basket assembly coupled with an impeller, according to the present disclosure;

FIG. 9 is a partial exploded view of a basket assembly and an impeller, according to the present disclosure;

FIG. 10A is a partial cross-sectional view of a locking system for a basket assembly in a deployed position, according to the present disclosure;

FIG. 10B is a partial cross-sectional view of a locking system for a basket assembly in a retracted position, according to the present disclosure;

FIG. 11 is a side perspective view of a skirt of a basket assembly configured to rotate with an outer basket relative to an impeller during an installation process, according to the present disclosure;

FIG. 12 is a side perspective view of a skirt of a basket assembly configured to be positioned on an impeller as an outer basket rotates relative to the skirt and the impeller during an installation process, according to the present disclosure;

FIG. 13A is a side perspective view of a basket assembly for a laundry appliance, according to the present disclosure;

FIG. 13B is a front elevational view of a basket assembly for a laundry appliance, according to the present disclosure;

FIG. 13C is a rear elevational view of a basket assembly for a laundry appliance, according to the present disclosure;

FIG. 13D is a first side elevational view of a basket assembly for a laundry appliance, according to the present disclosure;

FIG. 13E is a second side elevational view of a basket assembly for a laundry appliance, according to the present disclosure;

FIG. 13F is a top plan view of a basket assembly for a laundry appliance, according to the present disclosure;

FIG. 13G is a bottom plan view of a basket assembly for a laundry appliance, according to the present disclosure;

FIG. 14 is a side perspective view of a basket assembly including a connected base skirt with the basket assembly coupled with an impeller, according to the present disclosure;

FIG. 15 is a bottom perspective, partially exploded view of a basket assembly with an engagement bracket for engaging a skirt during rotation, according to the present disclosure;

FIG. 16 is a top perspective view of a skirt of a basket assembly, illustrating tabs for guiding rotation of inner and outer baskets, according to the present disclosure;

FIG. 17 is a partial top perspective view of an engagement bracket engaging a skirt in an installed position, according to the present disclosure;

FIG. 18 is a partial top perspective view of an engagement bracket engaging a skirt in an initial insertion position, according to the present disclosure;

FIG. 19A is a side perspective view of a basket assembly for a laundry appliance, according to the present disclosure;

FIG. 19B is a front elevational view of a basket assembly for a laundry appliance, according to the present disclosure;

FIG. 19C is a rear elevational view of a basket assembly for a laundry appliance, according to the present disclosure;

FIG. 19D is a first side elevational view of a basket assembly for a laundry appliance, according to the present disclosure;

FIG. 19E is a second side elevational view of a basket assembly for a laundry appliance, according to the present disclosure;

FIG. 19F is a top plan view of a basket assembly for a laundry appliance, according to the present disclosure;

FIG. 19G is a bottom plan view of a basket assembly for a laundry appliance, according to the present disclosure;

FIG. 20 is a side perspective view of a removable basket assembly positioned on an impeller, according to the present disclosure;

FIG. 21 is an exploded side perspective view of a removable basket assembly, according to the present disclosure;

FIG. 22 is a partial bottom perspective view of an outer basket with a connector, according to the present disclosure;

FIG. 23 is a side perspective view of a skirt of a removable basket assembly, according to the present disclosure;

FIG. 24 is a bottom perspective view of a skirt for a removable basket assembly, according to the present disclosure;

FIG. 25 is a partially cross-sectional view of an engagement between an outer basket, a locking system, and a skirt of a removably basket assembly, according to the present disclosure;

FIG. 26 is a top perspective cross-sectional view of an outer basket engaging with a skirt of a removable basket assembly, according to the present disclosure;

FIG. 27 is a side perspective view of a removable basket assembly having a cylindrical body, according to the present disclosure;

FIG. 28 is a side perspective view of a removable basket assembly having a cylindrical body and agitation fins, according to the present disclosure;

FIG. 29 is a side perspective view of a removable basket assembly positioned adjacent to a base of an impeller, according to the present disclosure;

FIG. 30 is a side perspective view of a removable basket assembly with a cover, according to the present disclosure;

FIG. 31 is a cross-sectional view of a removable basket assembly with a locking post, according to the present disclosure;

FIG. 32 is a cross-sectional view of a removable basket assembly in a drum, according to the present disclosure; and

FIG. 33 is a top perspective view of a removable basket assembly in a drum, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a laundry appliance with a removable basket assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

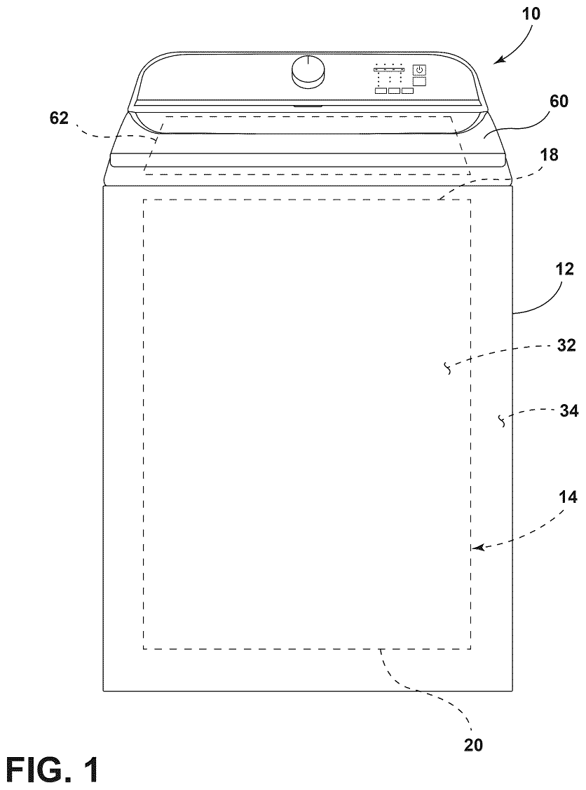

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

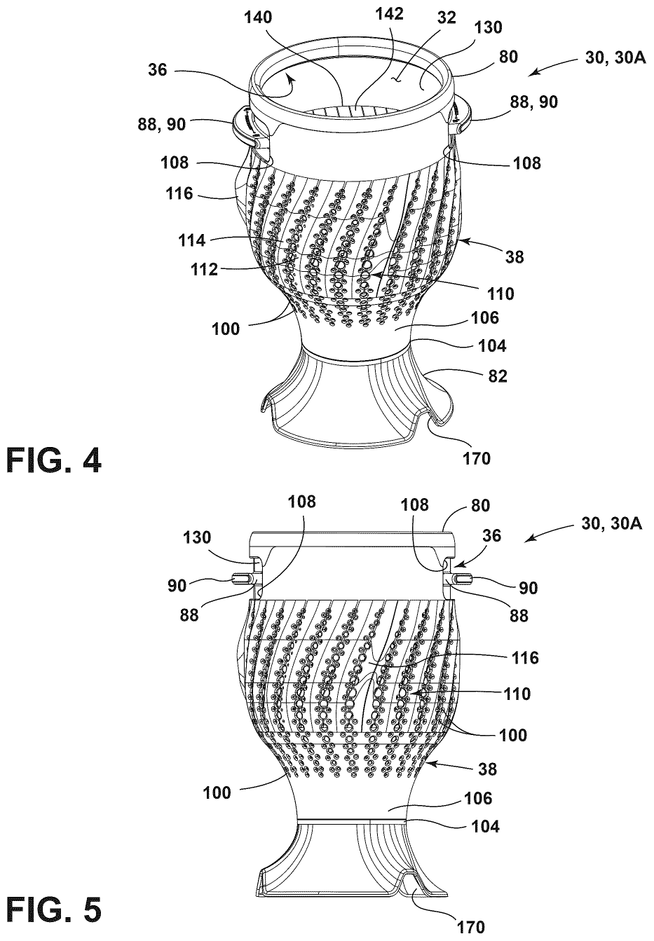

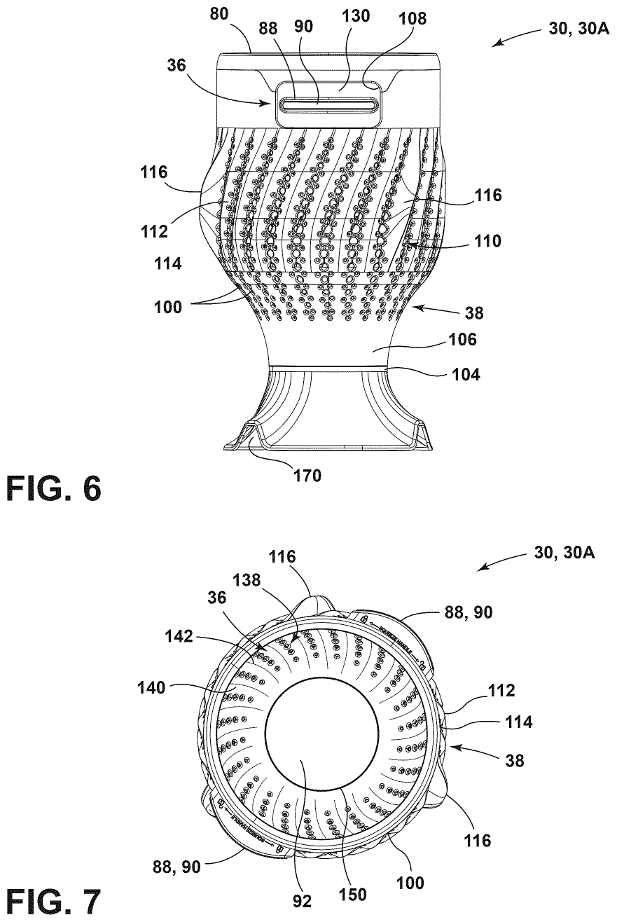

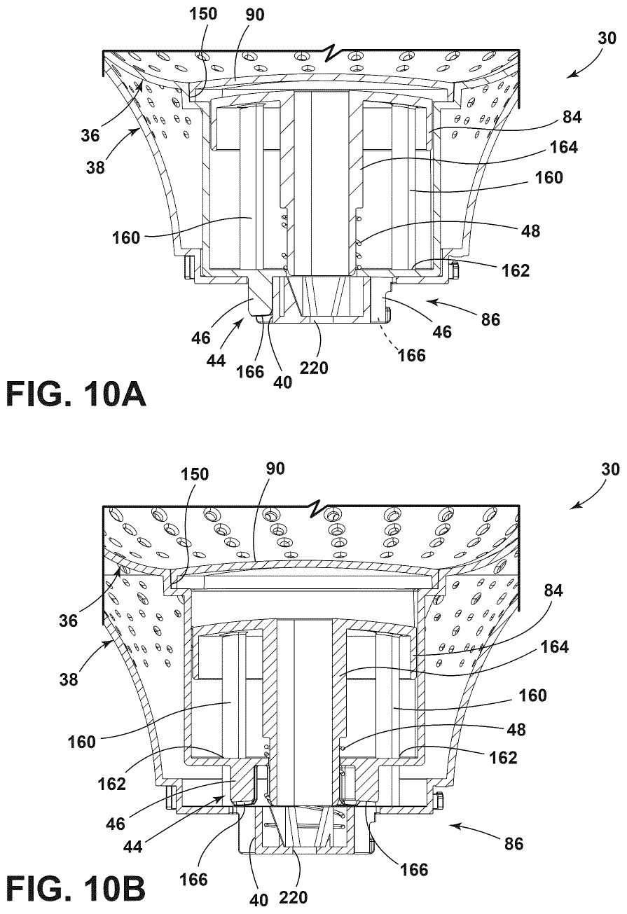

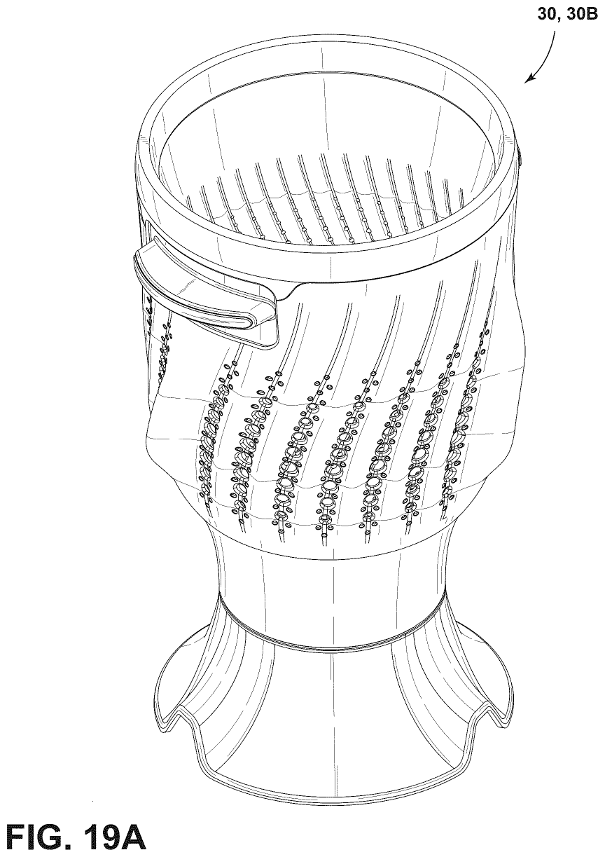

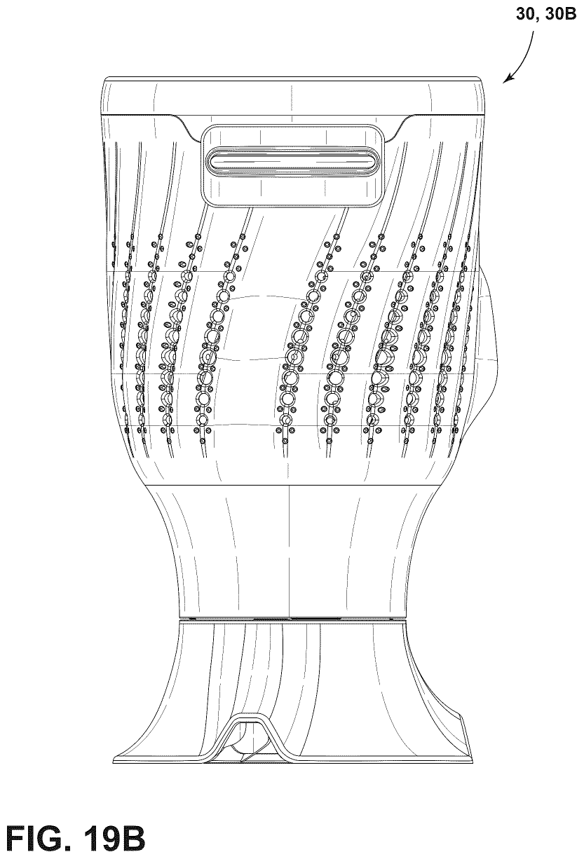

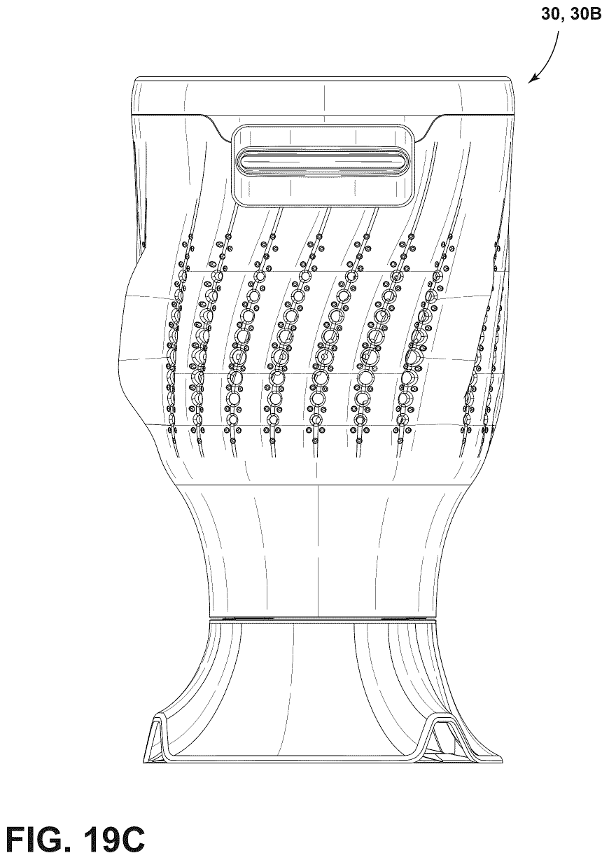

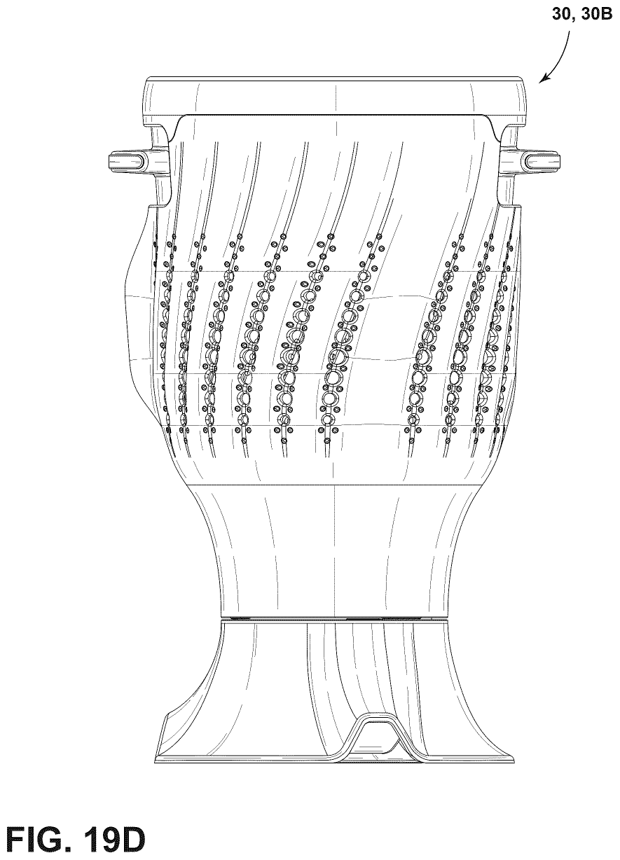

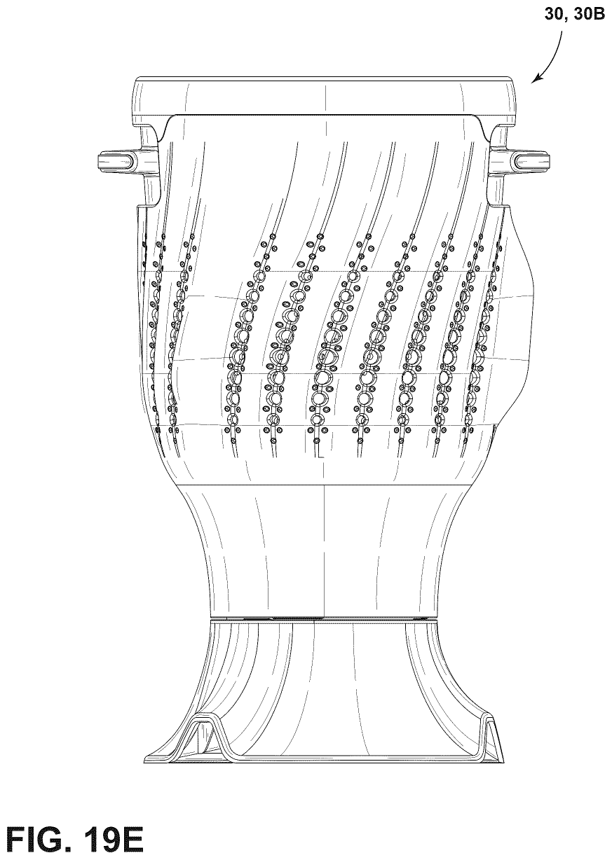

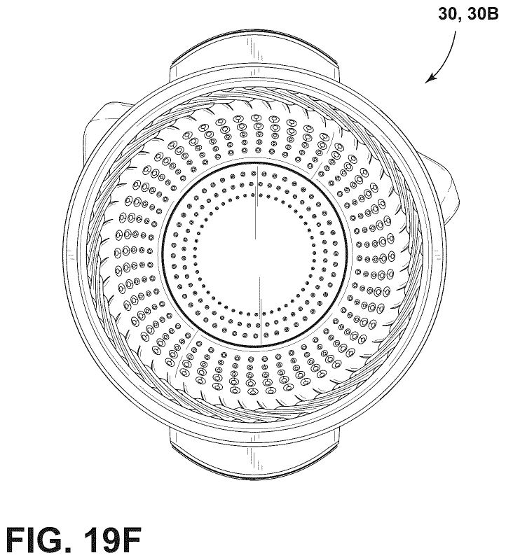

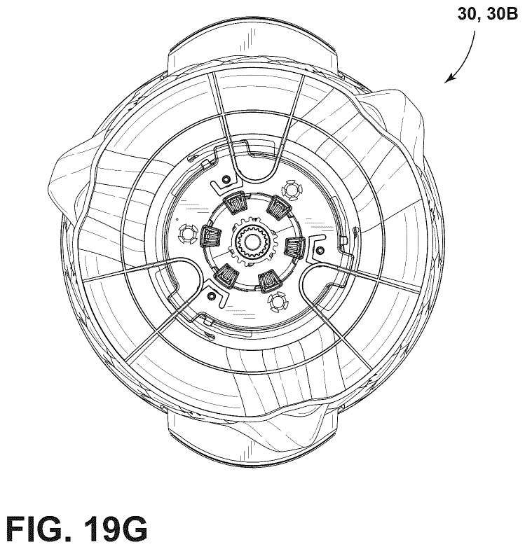

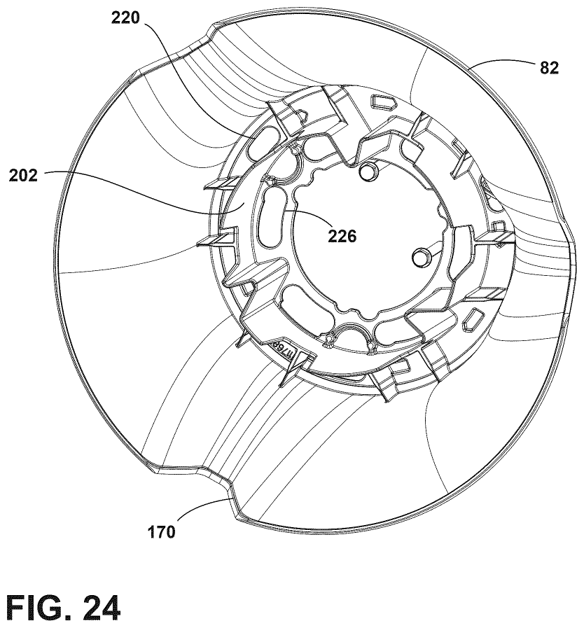

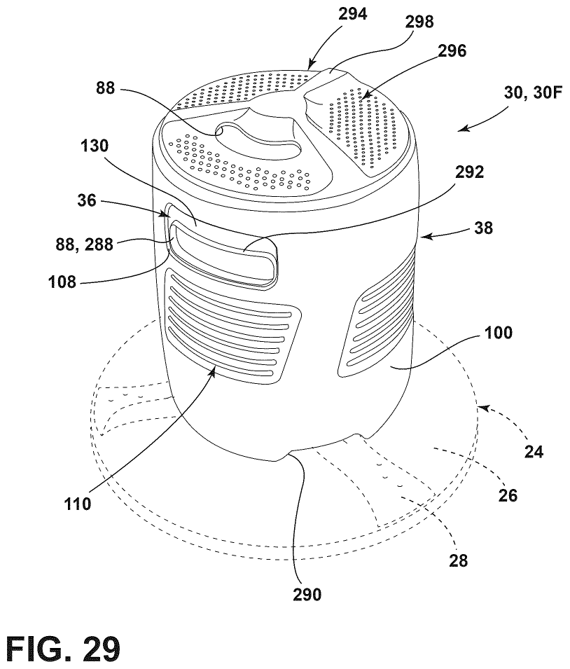

With reference to FIGS. 1-33, reference numeral 10 generally designates a laundry appliance 10 including a cabinet 12 and a drum 14 disposed within the cabinet 12. The drum 14 defines an interior 16. The drum 14 has a drum opening 18 opposite a closed end 20 along a rotational axis 22. An impeller 24 is operably coupled with the closed end 20 in the interior 16 of the drum 14. The impeller 24 includes a receiver 26 and at least one protrusion 28 proximate to the receiver 26. A basket assembly 30 is selectively couplable with the impeller 24. Different exemplary configurations of the basket assembly 30 are disclosed herein and may be referred to as basket assemblies 30A-30G. The basket assembly 30 separates the interior 16 of the drum 14 into an outer compartment 34 between the drum 14 and the basket assembly 30 and an inner compartment 32 within the basket assembly 30.

The basket assembly 30 may include an outer basket 38 and an inner basket 36 disposed within the outer basket 38. The inner basket 36 is movable within the outer basket 38 along the rotational axis 22. The basket assembly 30 includes a connector 40 configured to be positioned in the receiver 26. The connector 40 may be part of or coupled with the outer basket 38. The connector 40 includes at least one slot 42 configured to receive the protrusion(s) 28 of the impeller 24. A locking feature 44 is operably coupled with the connector 40. The locking feature 44 may be part of or coupled with the inner basket 36. The locking feature 44 includes at least one projection 46 operable between a retracted position and a deployed position. In certain aspects, the inner basket 36 with the locking feature 44 is operable between the retracted position and the deployed position. A biasing member 48 is configured to bias the locking feature 44 toward the deployed position to lock the protrusion(s) 28 in the slot(s) 42 and, consequently, lock the basket assembly 30 to the impeller 24. The impeller 24 and the basket assembly 30 are configured to rotate together during a laundry cycle.

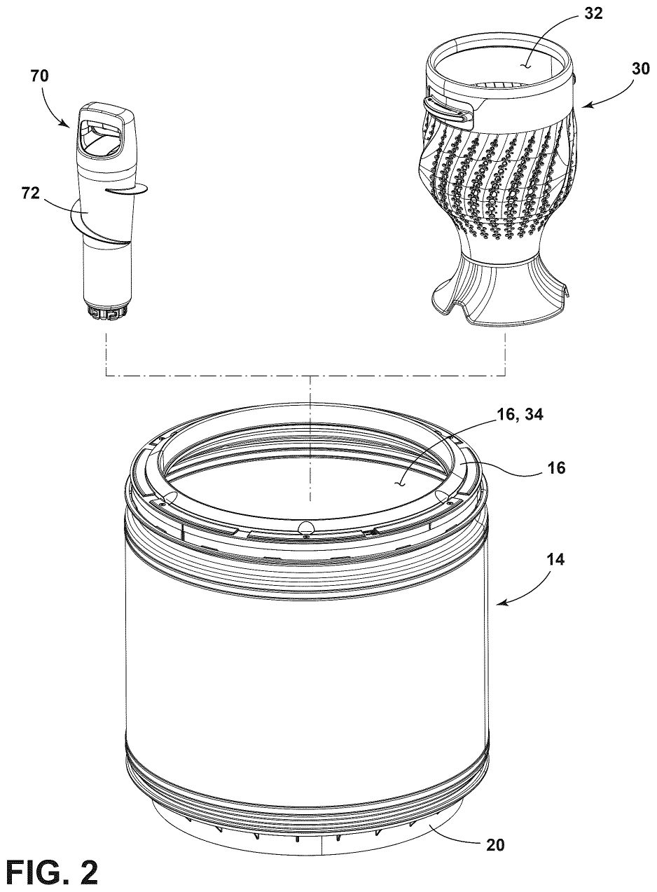

With reference to FIGS. 1 and 2, the laundry appliance 10 is illustrated as a top load washer. Generally, the laundry appliance 10 includes the cabinet 12, a tub disposed in the cabinet 12, and the drum 14 disposed within the tub. The cabinet 12 defines an access opening 60 for accessing the interior 16 of the drum 14. The laundry appliance 10 includes a door 62, illustrated as a top lid, which can selectively open and close the access opening 60. The laundry appliance 10 may be a vertical axis washer, a top load washer, or other laundry appliance 10.

The drum 14 is disposed within the cabinet 12 to align the drum opening 18 with the access opening 60. The drum opening 18 is an upper or top opening, and the closed end 20 is a bottom of the drum 14. Typically, the drum opening 18 and the closed end 20 are coaxial and arranged along the rotational axis 22. The interior 16 of the drum 14 is accessible via the access opening 60 and the drum opening 18. The drum 14 is operably coupled with a drive system for rotating the drum 14 about the rotational axis 22. The drive system is configured to rotate the drum 14 clockwise and/or counterclockwise during a laundry or wash cycle.

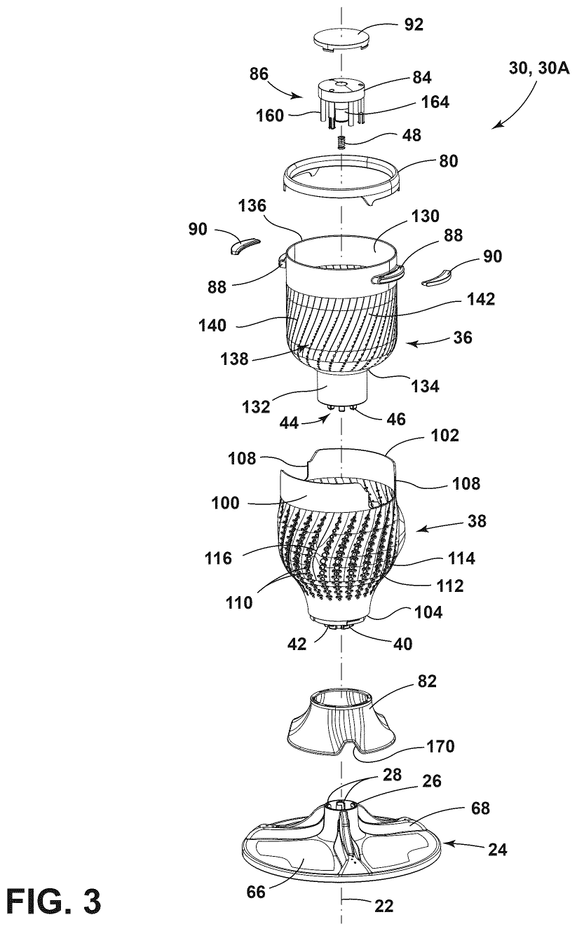

Referring to FIGS. 2 and 3, the impeller 24 may be disposed within the interior 16 of the drum 14 at the closed end 20. The impeller 24 may be operably coupled with the closed end 20 of the drum 14 and/or the drive system for rotating with the drum 14. The impeller 24 may include a base 66 extending across the closed end 20 of the drum 14 and the receiver 26, which is generally centrally located on the impeller 24 and positioned on the rotational axis 22. The impeller 24 also includes impeller fins 68, which typically extend radially outward from the receiver 26 and protrude upwardly from the base 66 into the interior 16 of the drum 14 to provide an agitation function during the laundry cycle.

In various aspects, the receiver 26 is configured to selectively receive and engage multiple laundry accessories 70, which may be interchanged with one another to provide different functions. For example, as illustrated in FIG. 2, the interchangeable laundry accessories 70 include an agitator 72 and the basket assembly 30. The agitator 72 and the basket assembly 30 may be selectively coupled to the impeller 24 for rotation with the impeller 24 and the drum 14 and may also be disengaged from the impeller 24 and removed from the drum 14. In this way, the laundry appliance 10 may be utilized with different accessories 70 coupled to the impeller 24 or without an accessory 70 coupled to the impeller 24.

Referring to FIGS. 3-7, the basket assembly 30A is illustrated, which is configured to couple to the receiver 26 to rotate with the impeller 24 about the rotational axis 22. The basket assembly 30A may include the outer basket 38, the inner basket 36 disposed within the outer basket 38, and an upper frame 80 to assist with coupling the inner basket 36 and outer basket 38. In certain aspects, the basket assembly 30A includes a base or skirt 82 coupled to the outer basket 38, which extends toward the impeller 24. The basket assembly 30A also includes a support guide 84 and a biasing member 48, which may be part of a locking system 86. The basket assembly 30A may also include handles 88 and handle covers 90, as well as a cap 92, which can form a floor of the inner compartment 32 of the basket assembly 30A.

The outer basket 38 includes a sidewall 100, which may be referred to as an outer sidewall 100. The outer sidewall 100 includes a top edge 102 that defines an upper opening into an interior of the outer basket 38 and a bottom edge 104. The outer sidewall 100 may have a first width at the top edge 102 and a second smaller width at the bottom edge 104. In this configuration, the outer sidewall 100 may have a “wine glass” shape, where an upper portion of the outer basket 38 is wider, and the outer basket 38 slopes or curves to the smaller second width. The narrower portion of the outer basket 38 may be referred to as a neck 106 of the basket assembly 30A. The upper opening may form the greatest width of the outer basket 38 or, alternatively, the outer sidewall 100 may curve outward from the top edge 102 before narrowing toward the bottom edge 104. This shape may maximize the capacity of the inner compartment 32 as well as the outer compartment 34 (FIG. 2) between the basket assembly 30A and the drum 14.

The outer sidewall 100 includes or defines outer openings 108 at or proximate to the top edge 102. In the illustrated configuration, the outer openings 108 are U-shaped indents formed by the top edge 102 of the outer basket 38. It is contemplated that the outer openings 108 may be apertures such that the top edge 102 defines upper boundaries for the outer openings 108 without departing from the teachings herein. The outer openings 108 may allow access to the handles 88 provided by or extending from the inner basket 36.

Referring still to FIGS. 3-7, the outer sidewall 100 may define a plurality of first or outer fluid apertures 110 to allow fluid communication between the inner compartment 32 (i.e., the area inside the inner basket 36) and the outer compartment 34 (i.e., the area outside of the outer basket 38) through the basket assembly 30A. In the illustrated configuration, the outer fluid apertures 110 are configured as rounded or oblong holes arranged in sets that extend along a height of the outer sidewall 100. The outer fluid apertures 110 may be any practicable configuration to allow fluid flow therethrough, including round, circular, oblong, elongated, curved, linear, etc.

The sets of outer fluid apertures 110 may be diagonal, curved, linear, or any other pattern. For example, in the illustrated configuration, the outer fluid apertures 110 are arranged in curved patterns that follow the shape of the outer sidewall 100 and promote an appearance of movement. In various aspects, the sets of the outer fluid apertures 110 may extend at least partially along the circumference of the outer sidewall 100. The angled or curved arrangements may assist with allowing fluid communication between the inner and outer compartments 32, 34 as the basket assembly 30A is rotated.

Moreover, the outer fluid apertures 110 may be the same size or may be different sizes based on the location along the outer sidewall 100. The sizes may change in each set or different sets may have different sized outer fluid apertures 110. In the illustrated configuration, the outer fluid apertures 110 at the top and bottom of each set of fluid apertures 110 may be smaller and the fluid apertures 110 in the middle of each set may be larger. This may allow different amounts of fluid to enter and/or exit the basket assembly 30A at different locations. This may be considered a vertical fade pattern in two directions (up and down). Other configurations may include a single direction vertical fade with the outer fluid apertures 110 decreasing in size in a single direction (top to bottom or bottom to top), a single direction horizontal fade with the outer fluid apertures 110 decreasing in size from one side to the other (left to right or right to left), a two direction horizontal fade with the outer fluid apertures 110 decreasing in size outward from middle outer fluid apertures 110, etc. Each of these configurations may allow fluid communication between the inner compartment 32 and the outer compartment 34. It is contemplated that the outer fluid apertures 110 may be any size(s) or shape(s) and in any practicable regular or irregular pattern or arrangement for allowing fluid communication between the inner and outer compartments 32, 34.

Referring still to FIGS. 3-7, the outer basket 38 may define ridges 112 and grooves 114 that extend along the height of the outer sidewall 100. The ridges 112 and grooves 114 may be linear or may be curved. The ridges 112 and grooves 114 may assist in agitating or moving the items and/or liquid in the outer compartment 34 and may also promote liquid movement into/through the outer fluid apertures 110. For example, in the illustrated configuration, the sets of the outer fluid apertures 110 may be arranged in the grooves 114 and spaced from adjacent sets by the ridges 112. This configuration may guide the liquid along the grooves 114 and through the outer fluid apertures 110.

The ridges 112 and grooves 114 may provide a textured structure to the outer sidewall 100, which may assist with moving laundry items and the wash fluid in the outer compartment 34 to provide an agitation function with the basket assembly 30A. Additionally or alternatively, at various intervals along the circumference of the outer sidewall 100, the ridges 112 may be replaced with agitation fins 116 extending outwardly from the outer sidewall 100. The agitation fins 116 may extend a greater distance outwardly than the ridges 112 to provide an increased agitation function to the items in the outer compartment 34. In this way, the basket assembly 30A may provide the agitation function to the items in the outer compartment 34.

Referring still to FIGS. 3-7, the basket assembly 30A includes the inner basket 36 positioned within the outer basket 38. The inner basket 36 includes a wall 130, which may be referred to as an inner sidewall 130, and a bottom or lower housing 132 extending from a lower edge 134 of the inner sidewall 130. The inner sidewall 130 may generally have a more cylindrical shape compared to the outer sidewall 100 to maximize the capacity of the inner basket 36. The inner sidewall 130 may have an upper edge 136 defining an upper opening into the inner compartment 32 and the lower edge 134. The inner basket 36 may be rounded at the bottom proximate to the lower edge 134.

The inner sidewall 130 is positioned adjacent to an inner surface of the outer sidewall 100. The lower edge 134 of the inner sidewall 130 is positioned proximate to where the outer basket 38 begins to narrow into the neck 106. The lower housing 132 may extend or be disposed in the neck 106 of the outer basket 38. This may maximize capacity of the inner and outer compartments 32, 34 and provide space for the lower housing 132.

The inner basket 36 includes a plurality of second or inner fluid apertures 138, which are configured to be sized, shaped, and arranged to generally correspond or match with the outer fluid apertures 110. The inner fluid apertures 138 may be coaxial, adjacent to, or otherwise aligned with the outer fluid apertures 110 to provide fluid flow paths through the inner and outer baskets 36, 38 via the outer and inner fluid apertures 110, 138. In this way, the fluid apertures 110, 138 align to form through-holes or channels 170 through the basket assembly 30A to provide fluid communication between the inner compartment 32 and the outer compartment 34. Typically, the inner fluid apertures 138 match the size(s), shape(s), arrangement(s), and location(s) of the outer fluid apertures 110.

In various aspects, the inner sidewall 130 includes ridges 140 and grooves 142. As illustrated, the inner fluid apertures 138 may be disposed along the ridges 140 to bring the inner fluid aperture 138 into closer proximity to the outer fluid apertures 110 arranged in the grooves 114 of the outer sidewall 100. The ridges 140 and grooves 142 provide a textured structure for an inner surface of the inner sidewall 130 to provide an agitation function to the laundry items within the basket assembly 30A. The ridges 140 and grooves 142 may be linear, diagonal, vertical, curved, etc. for providing the agitation function to the laundry items and the wash liquid, and may also promote liquid flow through the fluid apertures 110, 138. The ridges 140 and grooves 142 of the inner basket 36 may correspond with or be different than the ridges 112 and grooves 114 of the outer basket 38.

Typically, the ridges 140 and grooves 142 may be generally uniformly shaped around the circumference of the inner sidewall 130. The ridges 140 and grooves 142 may provide sufficient agitation for items in the inner compartment 32, such as delicates. It is also contemplated that at periodic intervals around the circumference, the ridges 140 may form or be replaced with agitator fins that extend inwardly into the inner basket 36 similar to the outwardly extending agitation fins 116 on the outer sidewall 100 without departing the teachings herein.

The inner basket 36 includes the handles 88, which are illustrated in this configuration as two outwardly protruding handles 88. The handles 88 may be on opposite portions of the inner basket 36, such as diametrically opposed to one another. The handles 88 extend outward from the inner sidewall 130. The basket assembly 30A may also include the handle covers 90, which can be positioned over the protruding handles 88. The handle covers 90 may provide a grasping material, such as a rubber or other materials, that may have increased friction for gripping the basket assembly 30A. This material with increased friction may be advantageous for gripping the handles 88 when the handles 88 are wet from the laundry cycle.

The protruding handles 88 are configured to extend through the outer openings 108 defined by the outer basket 38 and/or the outer basket 38 and the upper frame 80. Accordingly, there is typically the same number of handles 88 as outer openings 108. The handles 88 may be accessed from proximate to the outer surface of the outer basket 38, such as within the outer compartment 34 when the basket assembly 30A is installed in the drum 14. As described further herein, the handles 88 can be utilized for locking and unlocking the basket assembly 30A from the impeller 24.

Referring still to FIGS. 3-7, the basket assembly 30A generally includes the upper frame 80. The upper frame 80 may be integrally formed with the outer basket 38 or may be a separate component positioned over the top edge 102 and the upper edge 136 of the inner and outer baskets 36, 38. In various aspects, the inner sidewall 130 may be approximately the same height or slightly shorter than the outer sidewall 100. The inner basket 36 is movable upwards toward the upper frame 80. Accordingly, the relationship between the upper frame 80 and the inner basket 36 allows movement of the inner basket 36 parallel with the rotational axis 22. In this way, the inner basket 36 may generally be vertically movable relative to the outer basket 38 when the basket assembly 30A is coupled with the impeller 24. The upper frame 80 may also provide support for the handles 88 and may form an upper boundary of the outer openings 108 for the handles 88.

In various aspects, a lower opening 150 is formed by the lower edge 134 of the inner basket 36 where the inner sidewall 130 meets the lower housing 132. The cap 92 is positioned in this lower opening 150, which may at least substantially close the lower opening 150. The cap 92 may form a floor for the inner compartment 32, retaining the laundry items in the inner compartment 32 and reducing or preventing laundry items from moving into the lower housing 132.

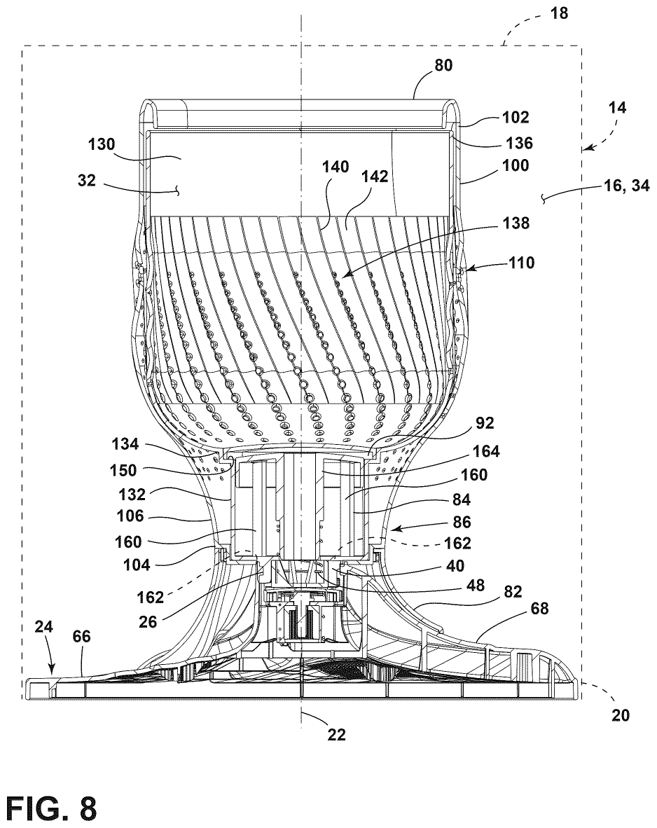

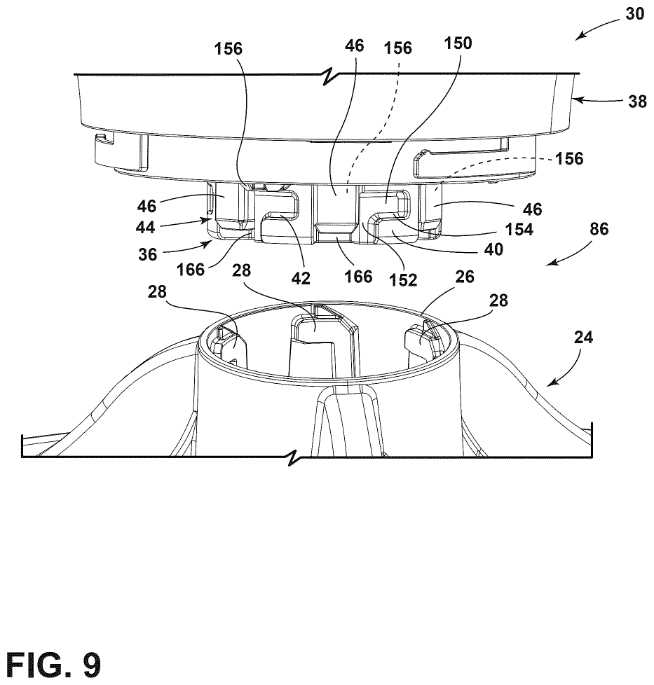

Referring to FIGS. 8 and 9, the basket assembly 30A includes the locking system 86 for coupling and locking the basket assembly 30A to the impeller 24. The locking system 86 may include one or more of the connector 40 with the slots 42, the locking feature 44 with the projections 46, the support guide 84, and the biasing member 48. Typically, the connector 40 is coupled with or part of (e.g., integrally formed with) the outer basket 38. The connector 40 may extend across an opening formed by the bottom edge 104 of the outer basket 38, generally forming the bottom of the outer basket 38. The connector 40 is configured to couple with the receiver 26 of the impeller 24. In various aspects, the impeller 24 includes the central receiver 26 in which the connector 40 is configured to be positioned. The receiver 26 includes protrusions 28, which extend inward into the receiving space of the receiver 26 for the connector 40.

In various aspects, the connector 40 includes the slots 42, which are configured to receive the protrusions 28 on the impeller 24. The slots 42 are arranged around the circumference of the connector 40, and each slot 42 is configured to receive a corresponding protrusion 28. The slots 42 may include an insertion portion 152 and a retaining or locking portion 154. The insertion portion 152 may be a vertical portion, extending generally parallel with the rotational axis 22. The locking portions 154 may generally extend along at least a portion of the circumference of the connector 40. In this way, the locking portions 154 may extend from the respective insertion portions 152 at an angle greater than 0°. Typically, the locking portions 154 may extend at an angle of between 75° and 115°, such as about 90° from the insertion portion 152.

Accordingly, to couple the basket assembly 30A with the impeller 24, the connector 40 is positioned in the receiver 26 with the protrusions 28 being moved into and along the insertion portions 152. The basket assembly 30A may be moved in an insertion direction (e.g., into the drum 14 toward the impeller 24) until the protrusions 28 abut the ends of the insertion portions 152. The basket assembly 30A may be rotated in a first rotational direction to move the protrusions 28 towards and to the ends of the locking portions 154. The basket assembly 30A may be coupled with the impeller 24 with two stages of motion. The two movements may assist with retaining the engagement between the impeller 24 and the basket assembly 30A and providing proper alignment between the two components.

The locking feature 44 with the projections 46 is typically coupled to or part of (e.g., integrally formed with) the inner basket 36. The locking feature 44 may form a bottom or floor of the lower housing 132 with the projections 46 extending away or downward from the floor. The connector 40 defines receiving openings 156, and the projections 46 are configured to extend through the receiving openings 156. The floor of the lower housing 132 may be configured to abut an inner side or surface of the connector 40 with the projections 46 extending through the receiving openings 156. The projections 46 may be movable in/through the receiving openings 156 as described herein.

Referring to FIGS. 8-10B, the support guide 84 is positioned within the lower housing 132. The support guide 84 includes peripheral posts 160, which may assist with guiding the movement of the inner basket 36. The posts 160 are coupled with the connector 40 and, in certain aspects, extend through the connector 40. The bottom of the inner basket 36 defines holes 162 through which the peripheral posts 160 extend to engage the connector 40. As the inner basket 36 moves, the holes 162 allow the inner basket 36 to move along the peripheral posts 160. Accordingly, the support guide 84 may assist with coupling the inner basket 36 to the outer basket 38 while allowing the movement of the inner basket 36 relative to the outer basket 38. The support guide 84 may be a fixed component, allowing the inner basket 36 to move along the support guide 84.

The support guide 84 may also include a central post 164, which can engage the connector 40. The central post 164 is configured to support the biasing member 48, which is illustrated as a coil spring. The central post 164 includes an upper segment having a greater width or diameter than a lower segment. The biasing member 48 may be coupled to the lower segment, and the upper segment may form an upper boundary for the biasing member 48.

The biasing member 48 is configured to engage one or both of the connector 40 and the bottom of the inner basket 36. A biasing force of the biasing member 48 biases the inner basket 36 and, consequently, the projections 46 of the locking feature 44 to the deployed position. The deployed position is typically a lowered position toward the connector 40. In the deployed position, the bottom of the inner basket 36 abuts the connector 40, and the projections 46 extend substantially or fully through the receiving openings 156 and into grooves 166 defined by a side surface of the connector 40.

As the locking feature 44 is coupled with or part of the inner basket 36, the handles 88 may be utilized to move the inner basket 36 and, consequently, the locking feature 44 against the biasing force to the retracted position. Accordingly, the movement of the handles 88 causes movement of the locking feature 44. In the retracted position, the projections 46 may not substantially protrude through the receiving openings 156. In some aspects, the projections 46 may be substantially or fully moved into the lower housing 132 in the retracted position. A pulling or upward force may be applied to the handles 88, which can move the inner basket 36 toward the upper frame 80 and the projections 46 to the retracted position. Upon release of the pulling force, the biasing member 48 is configured to return the inner basket 36 to the deployed position.

The connector 40 includes or defines the grooves 166 adjacent to each insertion portion 152 and aligned with the receiving openings 156. The grooves 166 are generally parallel with the insertion portions 152. Typically, the insertion portions 152 have a lesser depth than the grooves 166; however, the grooves 166 may be part of the insertion portions 152 without departing from the teachings herein. The grooves 166 can guide the movement of the projections 46 between the deployed and retracted positions. The projections 46 may more fully extend into the grooves 166 when in the deployed position and may protrude less or may not be positioned in the grooves 166 when in the retracted position. The projections 46 may extend at least partially along the locking portions 154 when in the deployed position in the grooves 166 to reduce or prevent movement of the protrusions 28 out of the locking portions 154.

The locking feature 44 may be utilized to lock the basket assembly 30A to the impeller 24, and more particularly lock the protrusions 28 of the impeller 24 in the slots 42. The projections 46 may be moved to the retracted position during the insertion and rotation of the basket assembly 30A, allowing the protrusions 28 to move along the slots 42 to install the basket assembly 30A. The projections 46 may then be adjusted to the deployed position to lock the protrusions 28 in the locking portions 154 of the slots 42. This may assist with retaining the engagement between the impeller 24 and the basket assembly 30A and reducing or preventing inadvertent disengagement of the basket assembly 30A.

Referring still to FIGS. 8-10B, to install the basket assembly 30A, the pulling force may be applied to the handles 88, which moves the inner basket 36 against the biasing force of the biasing member 48, and, consequently, moves the locking feature 44 to the retracted position. In other words, the locking feature 44 can move in response to the force applied to the handles 88. The basket assembly 30A can be moved into the drum 14, positioning the connector 40 in the receiver 26. The basket assembly 30A can be moved in the insertion direction, moving the protrusions 28 along the insertion portions 152 of the slots 42. The basket assembly 30A may then be rotated in the first rotational direction to move the protrusions 28 along the locking portions 154 of the slots 42. The handles 88 may then be released, and the biasing force of the biasing member 48 is configured to move the inner basket 36 toward the impeller 24. The locking feature 44 can adjust to the deployed position, moving the projections 46 along the grooves 166 to block the protrusions 28 from exiting the locking portions 154 of the slots 42. The laundry cycle may then be performed, and the basket assembly 30A can rotate with the impeller 24.

To remove the basket assembly 30A from the laundry appliance 10, the pulling force may be applied to the handles 88 to adjust the locking feature 44 to the retracted position, moving the projections 46 at least substantially out of the grooves 114 and toward/into the lower housing 132. The movement of the projections 46 may be sufficient to allow the protrusions 28 to be moved from the locking portions 154. The basket assembly 30A may be rotated in a second rotational direction (opposite the first rotational direction) to move the protrusions 28 along the locking portions 154 toward the insertion portion 152. The user may then pull or lift the basket assembly 30A in a removal direction, which is opposite the insertion direction. The user may move the basket assembly 30A toward and through the access opening 60 (FIG. 1), which moves the protrusions 28 along and out of the insertion portions 152 of the slots 42 to disengage the basket assembly 30A from the impeller 24. The basket assembly 30A may then be removed from the laundry appliance 10.

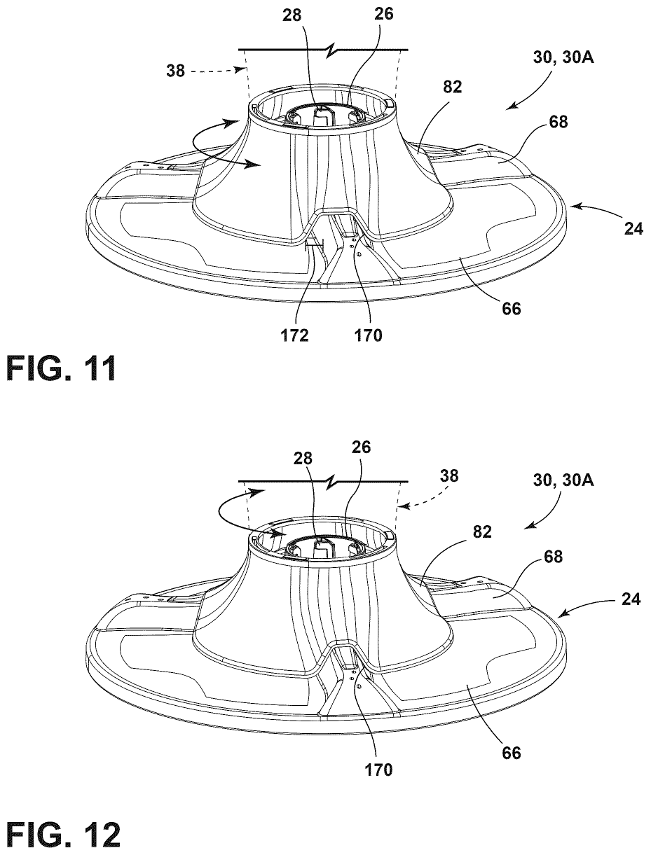

Referring to FIGS. 11 and 12, in various aspects, the basket assembly 30A includes the skirt 82, which may be coupled to the outer basket 38 proximate or at the bottom edge 104 of the outer sidewall 100. The skirt 82 may extend around the connector 40 and may extend between the outer sidewall 100 and base 66 of the impeller 24. The skirt 82 may increase in width to flare or cover more of the impeller 24, which may provide a more “hourglass” shape to the basket assembly 30A. The skirt 82 may assist with reducing or preventing items from getting caught between the impeller 24 and the basket assembly 30A during the laundry cycle or tangling around the neck 106 of the basket assembly 30A. The skirt 82 can also help guide the connection between the basket assembly 30A and the impeller 24, such as by aligning a bottom edge of the skirt 82 on the impeller 24 and the impeller fins 68 in channels 170.

The skirt 82 is typically coupled with the outer sidewall 100 to be part of the removable basket assembly 30A. The skirt 82 may not significantly impinge the agitation function of the impeller fins 68. The skirt 82 defines the channels 170 which are configured to be positioned over and receive the impeller fins 68. The channels 170 may form protruding components that retain the agitation function of the impeller fins 68. In various aspects, as illustrated in FIG. 11, the skirt 82 may be in a fixed relationship with the outer basket 38. In this regard, when the outer basket 38 is rotated to move the protrusions 28 along the slots 42, the skirt 82 is also rotated. In this configuration, the channels 170 are wider and configured to have a gap 172 between the skirt 82 and the impeller fins 68 to allow for the rotational movement of the skirt 82 over the impeller 24. For example, when initially installed, the gaps 172 may be on one side of the impeller fins 68, and as the basket assembly 30A is rotated, the gaps 172 may then be on the opposing side of the impeller fins 68. The gap 172 may be sufficient for allowing the maximum rotation of the basket assembly 30A. The basket assembly 30A may be configured to rotate up to about 20° or about 25° during the installation and removal processes.

As illustrated in FIG. 12, the outer sidewall 100 may be coupled with the skirt 82 and be configured to rotate relative to the skirt 82. In this way, when the basket assembly 30A is rotated during the installation process, the outer basket 38 may rotate relative to the skirt 82, which may remain generally stationary on the impeller 24. In this configuration, the channels 170 are narrower to extend adjacent to the surface of the impeller fins 68, reducing or minimizing the gaps 172 between the impeller 24 and the skirt 82. Minimizing these gaps 172 may reduce items from getting caught between the skirt 82 and the impeller 24.

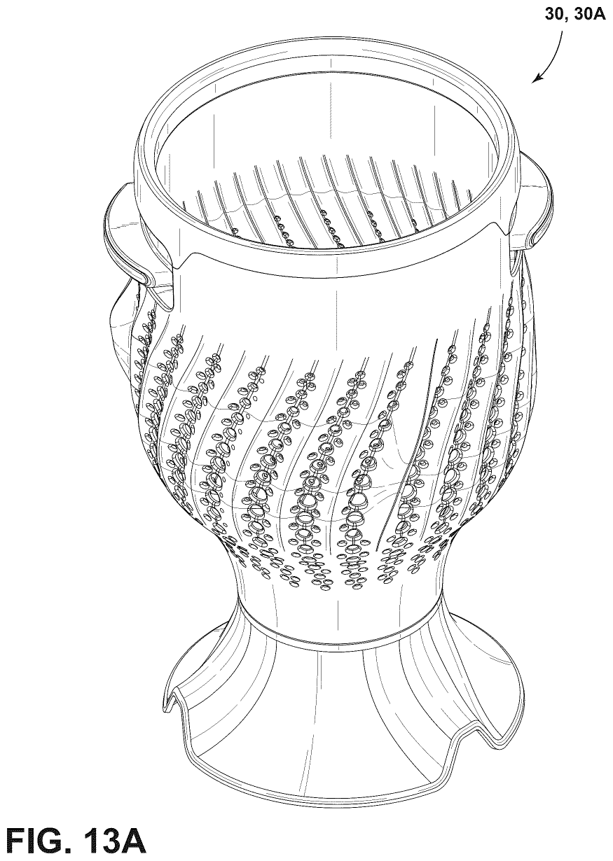

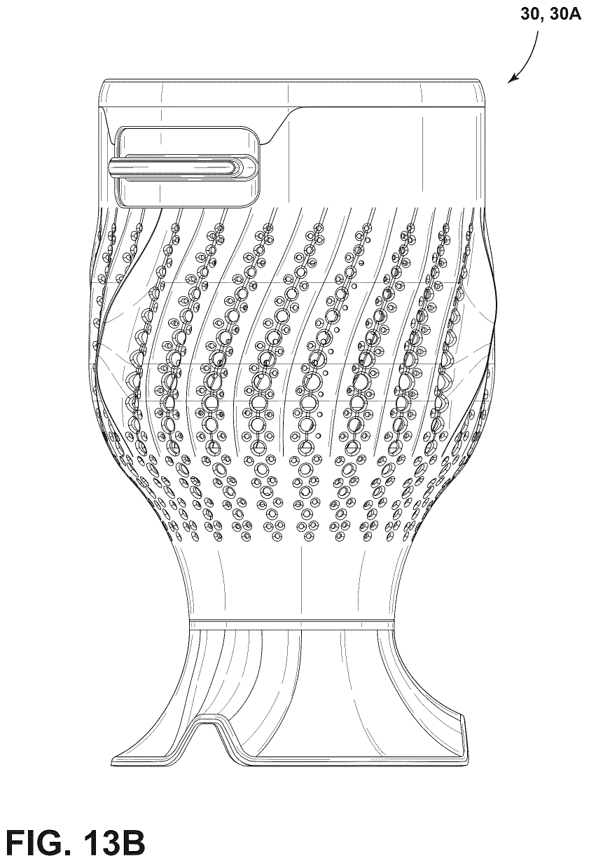

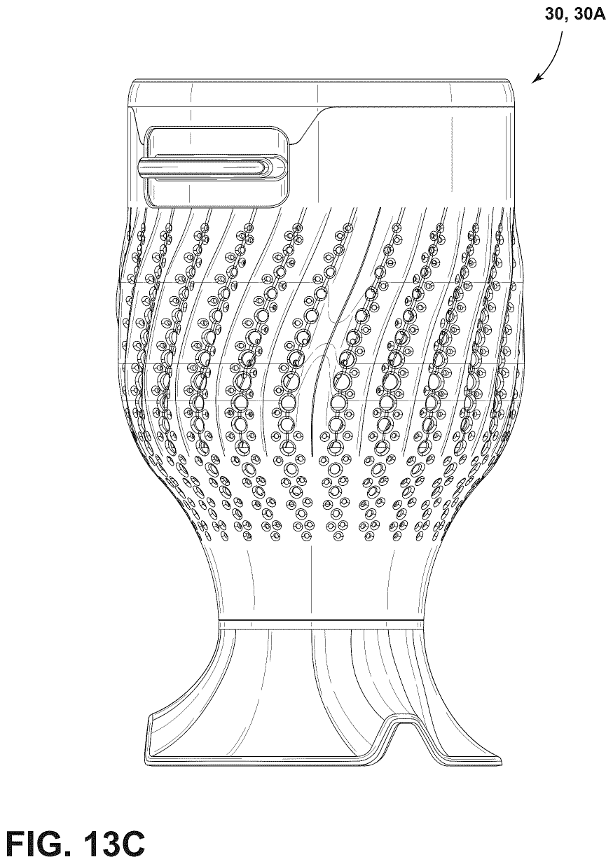

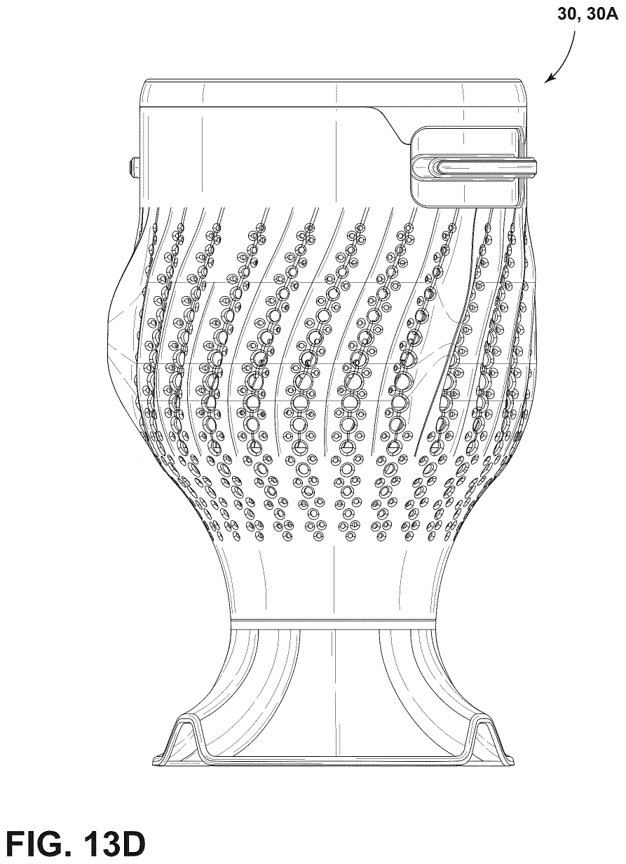

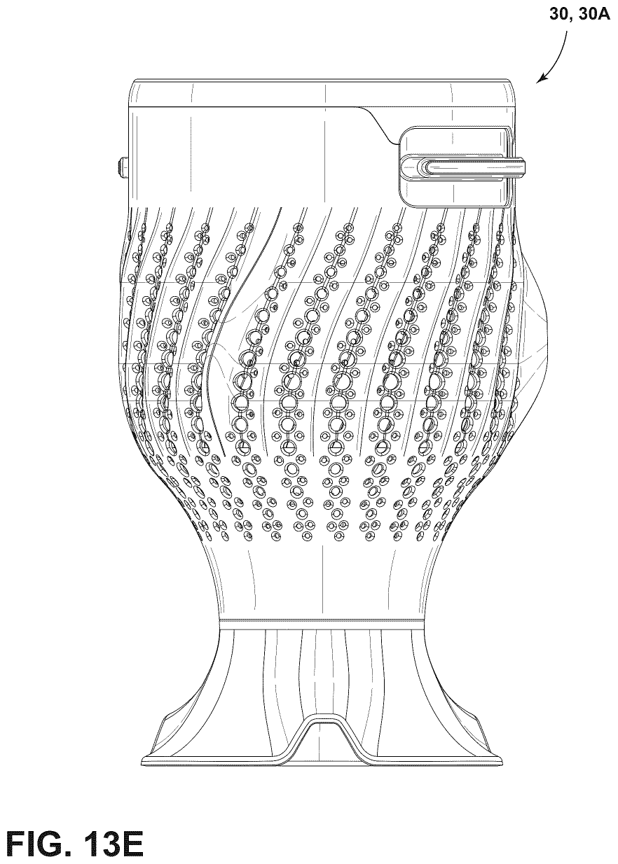

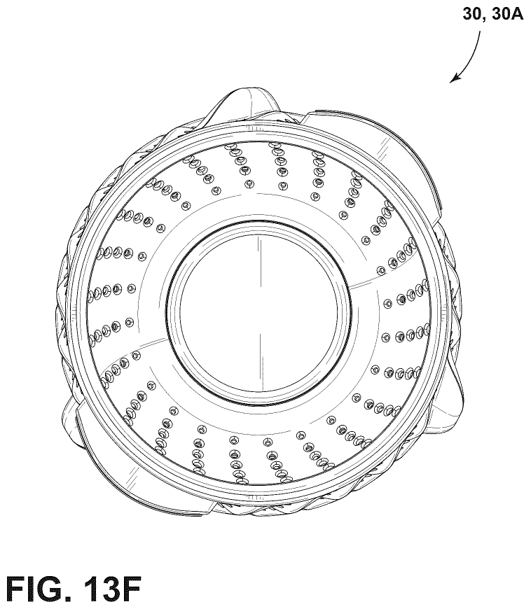

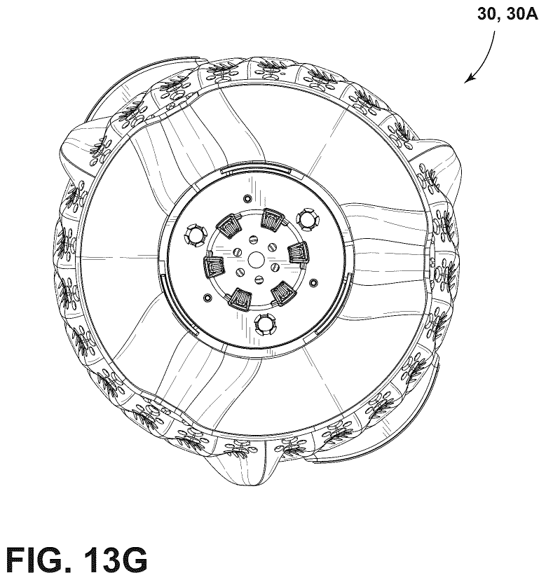

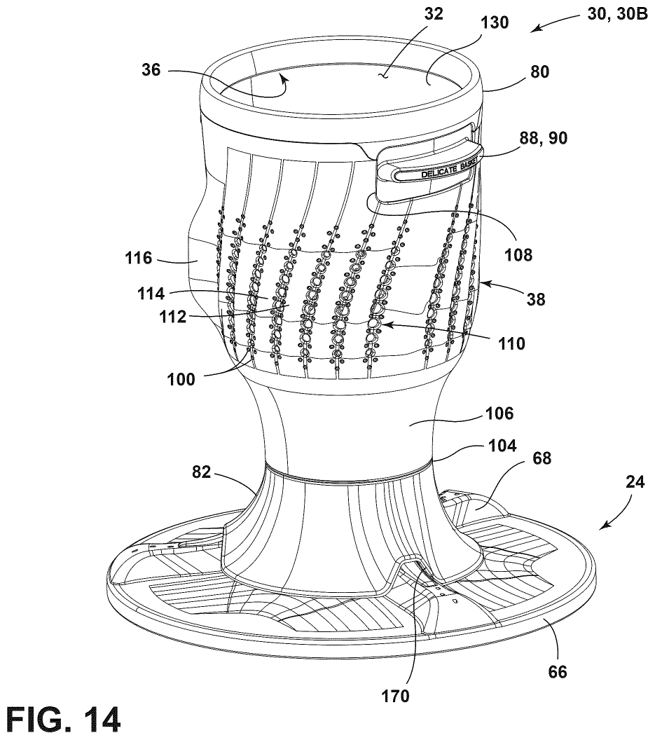

Referring again to FIGS. 3-12, as well as FIGS. 13A-13G, the basket assembly 30A is configured to divide the interior 16 of the drum 14 into the outer compartment 34 between the basket assembly 30A and the drum 14 and the inner compartment 32 within the basket assembly 30A. The inner compartment 32 and the outer compartment 34 are physically separated by the basket assembly 30A and remain in fluid communication with one another to concurrently wash two different/separate groups of items in a single laundry cycle. For example, the inner compartment 32 may be utilized for delicates, which may benefit from being separated from coarser materials that are kept in the outer compartment 34.

The basket assembly 30A may be shaped to maximize capacity within the inner compartment 32 and the outer compartment 34. The basket assembly 30A may have the first width at the top, narrow at the neck 106, and increase in width or flare again with the skirt 82. Accordingly, the basket assembly 30A may define a slim “wine glass” or “hourglass” shape. The wider top of the basket assembly 30A may increase capacity for the inner compartment 32, while the narrower neck 106 may increase capacity in the outer compartment 34 around the basket assembly 30A. Accordingly, the user may insert items into the inner compartment 32, as well as around the outer sidewall 100 of the outer basket 38 in the outer compartment 34.

Referring to FIGS. 14-19G, the basket assembly 30B is illustrated, which is substantially similar to the basket assembly 30A described with respect to FIGS. 3-13G with the primary differences being the overall shape of the basket assembly 30B and the relationship between the baskets 36, 38 and the skirt 82. The basket assembly 30 has the inner basket 36 disposed in the outer basket 38. Similar to the basket assembly 30A, the basket assembly 30B is configured to couple to the receiver 26 to rotate with the impeller 24 about the rotational axis 22. The basket assembly 30B may include the outer basket 38, the inner basket 36 disposed within the outer basket 38, and the upper frame 80 to assist with coupling the inner basket 36 and outer basket 38. The basket assembly 30B also includes the skirt 82 coupled to the outer basket 38, which extends toward the impeller 24. The skirt 82 may remain coupled with the outer basket 38 as the basket assembly 30B is installed in and removed from the laundry appliance 10 (FIG. 1).

The outer sidewall 100 may have a narrow “wine glass” shape, where an upper portion of the outer basket 38 is wider, and the outer basket 38 slopes or curves to the smaller second width at the neck 106. The skirt 82 can extend from the neck 106, widening to form an “hourglass” shape. The “hourglass” shape of the basket assembly 30B may be narrower than that of the basket assembly 30A. This narrower “hourglass” shape of the basket assembly 30B may maximize the size of the inner compartment 32 while providing more space for the outer compartment 34.

The outer sidewall 100 may define the plurality of outer fluid apertures 110 to allow fluid communication between the inner compartment 32 (i.e., the area inside the inner basket 36) and the outer compartment 34 (i.e., the area outside of the outer basket 38, see FIG. 1) through the basket assembly 30B. Similarly, the inner sidewall 130 may include the plurality of inner fluid apertures 138, which are configured to be sized, shaped, and arranged to generally correspond or match with the outer fluid apertures 110. Additionally, one or both of the outer basket 38 and the inner basket 36 may define ridges 112, 140 and grooves 114, 142 that extend along the height of the outer sidewall 100 to assist with agitation of the laundry items.

The inner basket 36 includes the handles 88, which extend through the outer openings 108 defined by the outer basket 38 and/or the outer basket 38 and the upper frame 80. The handles 88 are configured to control the locking system 86 that couples and locks the basket assembly 30B to the impeller 24. The locking system 86 includes one or more of the connector 40 with the slots 42, the locking feature 44 with the projections 46, the support guide 84, and the biasing member 48.

The connector 40 is configured to be positioned in the central receiver 26 of the impeller 24. The protrusions 28 of the receiver 26 are received in the slots 42 of the connector 40. During insertion, the protrusions 28 are moved vertically into the insertion portions 152 and then horizontally into the locking portions 154 as the baskets 36, 38 are rotated. With the protrusions 28 in the locking portions 154, the handles 88 can be released or moved toward the impeller 24 (e.g., downward) to move the projections 46 through the receiving openings 156 and into the grooves 166, locking the protrusions 28 in the slots 42 and, consequently, the basket assembly 30B to the impeller 24.

Accordingly, to couple the basket assembly 30B with the impeller 24, the connector 40 is positioned in the receiver 26 with the protrusions 28 being moved into and along the insertion portions 152. The basket assembly 30B may be moved in an insertion direction (e.g., into the drum 14 toward the impeller 24) until the protrusions 28 abut the ends of the insertion portions 152. The basket assembly 30B may be rotated in a first rotational direction to move the protrusions 28 towards and to the ends of the locking portions 154. The basket assembly 30B may be coupled with the impeller 24 with two stages of motion. The two movements may assist with retaining the engagement between the impeller 24 and the basket assembly 30B and providing proper alignment between the two components.

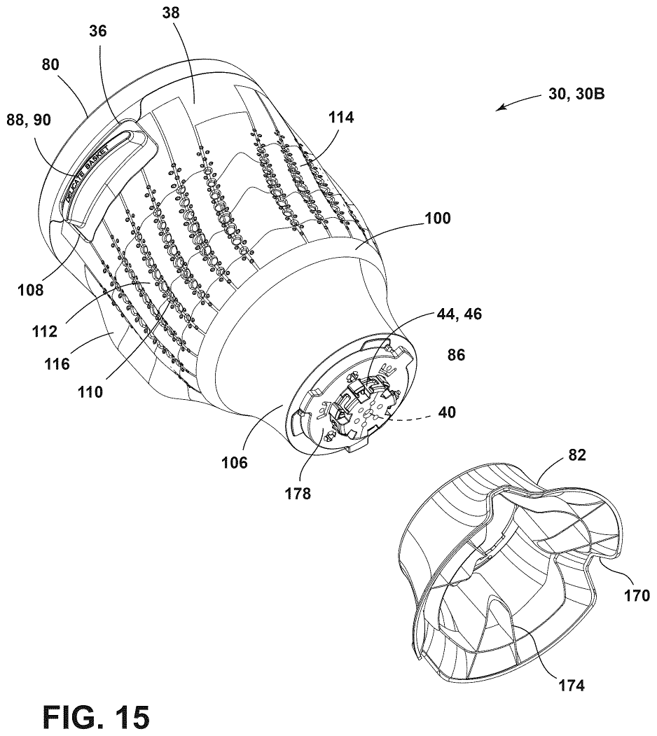

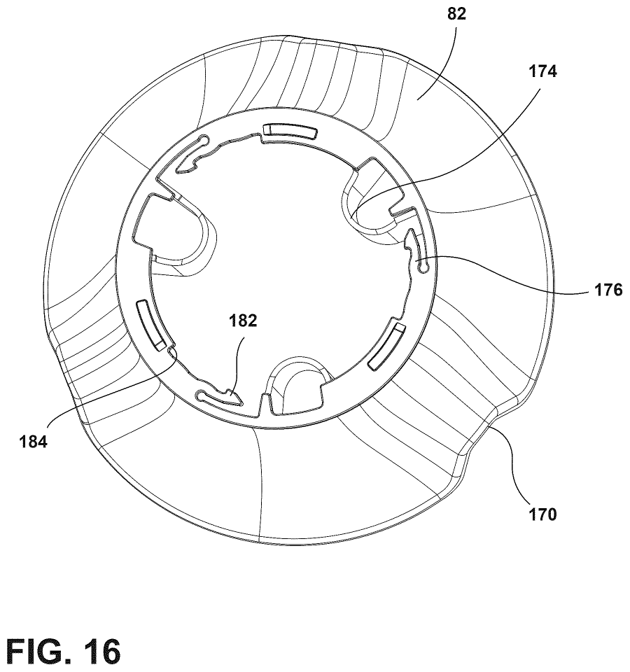

Referring to FIGS. 15 and 16, as the basket assembly 30B is moved to position the connector 40 in the receiver 26, the skirt 82 is positioned on or over the impeller 24. The skirt 82 may rest on the impeller 24 or, alternatively, the skirt 82 may be spaced slightly from the impeller 24 with the basket assembly 30B supported by the engagement between the connector 40 and the receiver 26. The skirt 82 defines the channels 170, which are configured to be positioned over and receive the impeller fins 68. The skirt 82 also includes guides 174 coupled to the skirt 82 between adjacent channels 170. The guides 174 extend inwards towards the rotational axis 22 and the central receiver 26. The guides 174 may generally remain spaced from the central receiver 26; however, the guides 174 may abut the central receiver 26 without departing from the teachings herein.

The guides 174 can assist with positioning the basket assembly 30B on or over the impeller 24 when viewing the engagement at the bottom of the drum 14 may be difficult. For example, the guides 174 may extend inward toward the receiver 26, which may form a receiving location for positioning the receiver 26 centrally under the skirt 82. Further, the guides 174 may fit between the impeller fins 68, which can assist with positioning the fins 68 in the channels 170. The guides 174 being positioned over the impeller fins 68 can reduce or prevent the basket assembly 30B from fully being positioned over the impeller 24, providing feedback to the user of misalignment in installation. The basket assembly 30B can be moved or rotated to position the guides 174 between adjacent impeller fins 68, which assists with aligning the channels 170 with the impeller fins 68 to fully position the basket assembly 30B over the impeller 24. The guides 174 can assist with aligning the components of the basket assembly 30B with the impeller 24 for proper installation, which can be difficult to see at the bottom of the drum 14 and/or under the basket assembly 30B.

Prior to installation, the baskets 36, 38 may be in an initial insertion position relative to the skirt 82. The outer basket 38 and/or the skirt 82 may include indicia for confirming that the baskets 36, 38 are in the insertion position. For example, each of the outer basket 38 and the skirt 82 may include an arrow or other indicator, and the indicators are aligned with one another when the basket assembly 30B is in the insertion position. The insertion position properly aligns the baskets 36, 38 with the skirt 82 to allow rotation of the baskets 36, 38 when the basket assembly 30B is on the impeller 24. As the baskets 36, 38 rotate to engage the impeller 24, the baskets 36, 38 rotate relative to the skirt 82, moving to an installed position. In this way, the skirt 82 remains substantially stationary as the baskets 36, 38 rotate to the installed position.

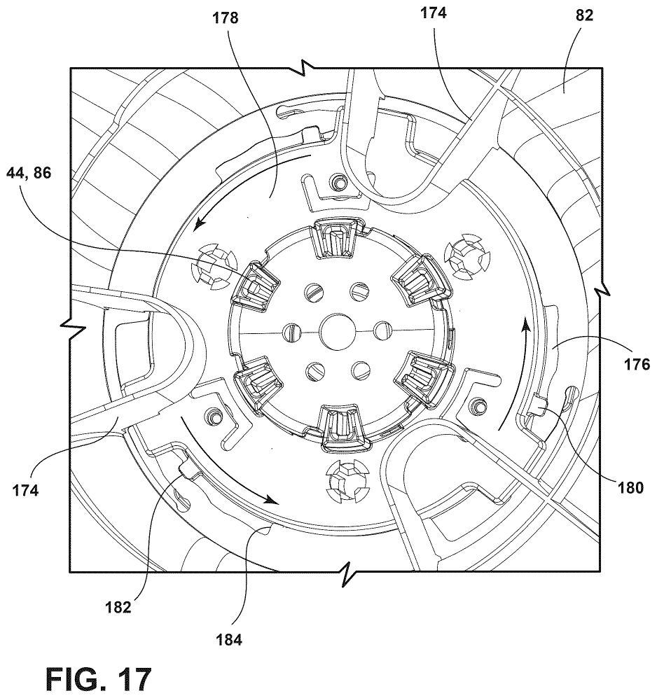

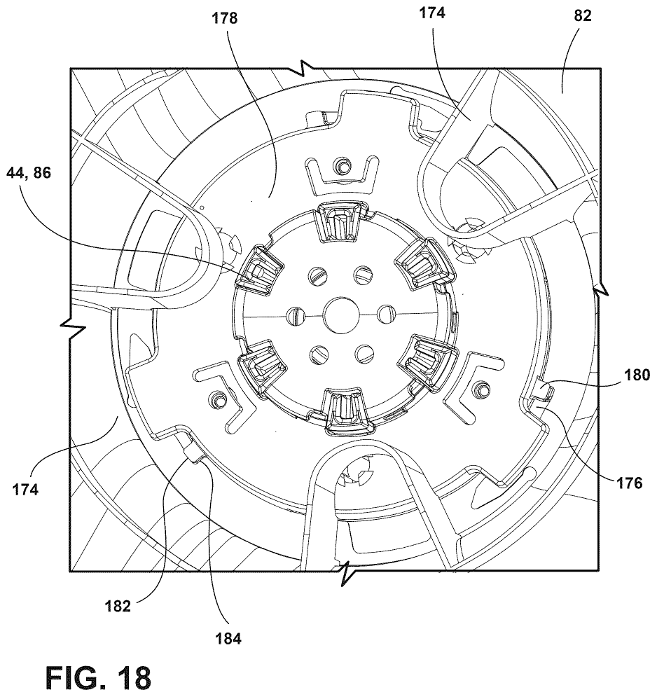

Referring to FIGS. 16-18, the skirt 82 and the outer basket 38 include mating or engaging features to guide and limit movement of the baskets 36, 38 between the insertion position (FIG. 18) and the installed position (FIG. 17). These features can assist with fully rotating the baskets 36, 38 to the installed position. The skirt includes at least one flexible extension 176 and, typically, multiple flexible extensions 176 arranged along or proximate to a top edge of the skirt 82 that engages the outer basket 38. The flexible extensions 176 extend around the circumference of the connector 40, extending at an angle from and proximate to the top edge of the skirt 82. Distal ends of the flexible extensions 176 are offset from the proximal ends and spaced from the top edge. The spacing allows the flexible extensions 176 to slightly deform toward the top edge in response to engagement from the outer basket 38.

The basket assembly 30B includes an engagement bracket 178 that extends over the connector 40 and the bottom of the outer sidewall 100 of the outer basket 38. The engagement bracket 178 may be integrally formed with the outer wall 100 or a separate component coupled to the outer basket 38. The engagement bracket 178 defines a plurality of holes and/or slots that align with the features of the connector 40 to not impede movement of the projections 46 into the grooves 166 or the protrusions 28 into the slots 42.

The engagement bracket 178 includes tabs 180 proximate to the bottom of the outer wall 100. The tabs 180 extend outwardly from the rotational axis 22 to engage the flexible extensions 176. The tabs 180 are configured to slide along the flexible extensions 176 as the baskets 36, 38 rotate between the insertion and installed positions. This sliding engagement can assist in controlling the rotation of the baskets 36, 38.

The distal ends of the flexible extensions 176 include or define detents 182, respectively. The detents 182 are configured to receive the tabs 180 when the baskets 36, 38 are fully in the installed position. The detents 182 may provide feedback to the user that the baskets 36, 38 are fully rotated to the installed position. The detents 182 may also reduce or prevent rotation of the baskets 36, 38 in the first direction beyond the installed position. The flexible extensions 176 may be configured to deflect or deform slightly to allow the tabs 180 to be fully positioned in the detents 182 and to move out of the detents 182. This may more securely hold the tabs 180 in the detents 182, reducing inadvertent rotation of the baskets 36, 38 relative to the skirt 82.

The engagement bracket 178 also includes stoppers 184 proximate to the proximal ends of the flexible extensions 176. The tabs 180 are configured to abut the stoppers 184 when the baskets 36, 38 are fully in the insertion position. The stoppers 184 may provide feedback to the user that the baskets 36, 38 are fully rotated to the insertion position to allow the basket assembly 30B to be removed from the appliance 10 (FIG. 1). The stoppers 184 may reduce or prevent rotation of the baskets 36, 38 in the second direction beyond the insertion position, which could at least partially disengage the skirt 82 from the baskets 36, 38. Accordingly, the stoppers 184 assist in maintaining the skirt 82 as an attached component of the basket assembly 30B.

Referring still to FIGS. 16-18, the detents 182 and the stoppers 184 may define the range of motion of the baskets 36, 38 relative to the skirt 82 and, consequently, the impeller 24. The detents 182 and the stoppers 184 may also assist in maintaining proper engagement and alignment between the baskets 36, 38 and the skirt 82 when the basket assembly 30B is removed from the appliance 10. In this way, proper alignment for insertion may be confirmed before the basket assembly 30B is moved into the laundry appliance 10.

The rotation of the baskets 36, 38 relative to the skirt 82 allows the channels 170 to be smaller to reduce the gap 172 between the basket assembly 30B and the impeller fins 68. Further, the guides 174 can be utilized to assist the user in positioning the basket assembly 30B on the impeller 24. The flexible extensions 176 with the detents 182 and the stoppers 184 engaged with the tabs 180 can assist in controlling and guiding rotation of the baskets 36, 38 relative to the skirt 82, which consequently, controls and guides rotations of the baskets 36, 38 relative to the impeller 24 for locking the basket assembly 30B to the impeller 24.

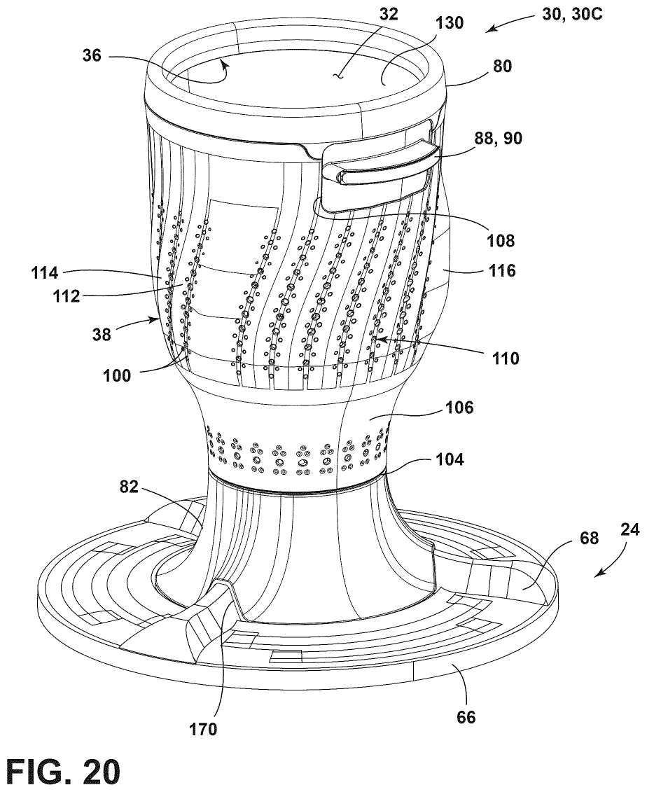

Referring to FIGS. 20-26, the basket assembly 30C is illustrated, which is substantially similar to the basket assembly 30B illustrated in FIGS. 14-19G with the primary differences being the fluid flow through the baskets 36, 38 and the relationship between the baskets 36, 38 and the skirt 82. Similar to the basket assembly 30B, the basket assembly 30C is configured to couple to the receiver 26 to rotate with the impeller 24 about the rotational axis 22. The basket assembly 30C may include the outer basket 38, the inner basket 36 disposed within the outer basket 38, and the upper frame 80 to assist with coupling the inner basket 36 and outer basket 38. The basket assembly 30C also includes the skirt 82 coupled to the outer basket 38, which extends toward the impeller 24. The skirt 82 may remain coupled with the outer basket 38 as the basket assembly 30C is installed in and removed from the laundry appliance 10 (FIG. 1).

The outer sidewall 100 may have the narrow “wine glass” shape, where the upper portion of the outer basket 38 is wider, and the outer basket 38 slopes or curves to the smaller second width at the neck 106. The skirt 82 can extend from the neck 106, widening to form the “hourglass” shape. The outer sidewall 100 can include the ridges 112, grooves 114, and agitation fins 116, which may assist with moving laundry items and the wash fluid in outer compartment 34 to provide an agitation function with the basket assembly 30C. The agitation fins 116 may be narrower toward the bottom and wider toward the top, forming a tapering or “V” shape. The agitation fins 116 may have grooves 114 defined therein, which can provide increased texture for increase agitation and define the “V” shape.

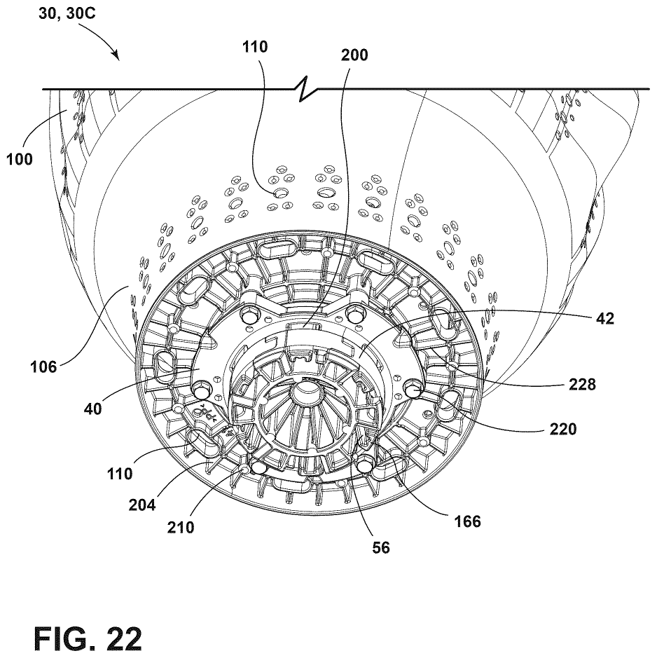

The outer sidewall 100 may define the plurality of outer fluid apertures 110 to allow fluid communication between the inner compartment 32 (e.g., the area inside the inner basket 36) and the outer compartment 34 (e.g., the area outside of the outer basket 38, see FIG. 1) through the basket assembly 30C. The outer fluid apertures 110 in this configuration may also be formed on the neck 106 of the outer basket 38. Additionally, outer fluid apertures 110 may be defined on the bottom of the outer sidewall 100 (e.g., facing toward the impeller 24), as illustrated in FIG. 22. The additional outer fluid apertures 110 can assist with draining fluid from the basket assembly 30B.

Similarly, the inner sidewall 130 of the inner basket 36 may include the plurality of inner fluid apertures 138, which are configured to be sized, shaped, and arranged to generally correspond or match with the outer fluid apertures 110. The inner fluid apertures 138 may be larger in this configuration. Similar to the outer sidewall 100, the inner sidewall 130 can also include additional inner fluid apertures 138 to assist with draining. The additional inner fluid apertures 138 can be defined on or proximate to the curved bottom portion of the inner sidewall 130 proximate to the lower housing 132.

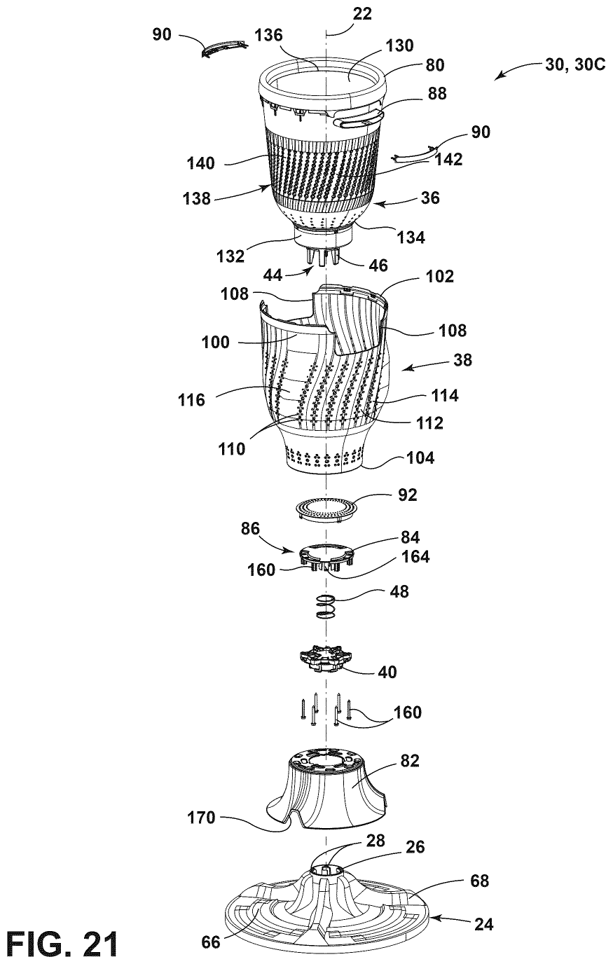

Referring still to FIGS. 20 and 21, the inner sidewall 130 may narrow proximate to the lower housing 132. This may assist with decreasing the size of the basket assembly 30C. Additionally, the inner basket 36 may define ridges 140 and grooves 142 that extend along the height of the inner sidewall 130 to assist with agitation of the laundry items. The inner basket 36 includes the handles 88 configured to control the locking system 86 that couples and locks the basket assembly 30C to the impeller 24. The locking system 86 includes one or more of the connector 40 with the slots 42, the locking feature 44 with the projections 46, the support guide 84, and the biasing member 48.

Referring now to FIGS. 21 and 22, the connector 40 is configured to be positioned in the central receiver 26 of the impeller 24. The protrusions 28 of the receiver 26 are received in the slots 42 of the connector 40. The connector 40 includes a ring 200 extending along a circumference of the connector 40. The ring 200 at least partially defines the slots 42 for the protrusions 28. The slots 42 may be shallower in this configuration. During insertion, the protrusions 28 are moved vertically into the insertion portions 152 along the ring 200 and then horizontally along the ring 200 into the locking portions 154 as the baskets 36, 38 are rotated.

With the protrusions 28 in the locking portions 154, the handles 88 can be released or moved toward the impeller 24 (e.g., downward) to move the projections 46 through the receiving openings 156 and into the grooves 166, locking the protrusions 28 in the slots 42 and, consequently, the basket assembly 30C to the impeller 24. The grooves 166 may be partially enclosed by the ring 200, such that the ring 200 extends across the grooves 166, forming a channel for receiving the projections 56. The ring 200 may assist with reducing interference between the protrusions 28 and the projections 56, as well as providing additional security in the engagement between the grooves 166 and the projections 56.

Accordingly, to couple the basket assembly 30C with the impeller 24, the connector 40 is positioned in the receiver 26 with the protrusions 28 being moved into and along the insertion portions 152. The basket assembly 30C may be moved in an insertion direction (e.g., into the drum 14 toward the impeller 24) until the protrusions 28 abut the ends of the insertion portions 152. The basket assembly 30C may be rotated in a first rotational direction to move the protrusions 28 towards and to the ends of the locking portions 154. The basket assembly 30C may be coupled with the impeller 24 with two stages of motion. The two movements may assist with retaining the engagement between the impeller 24 and the basket assembly 30C and providing proper alignment between the two components.

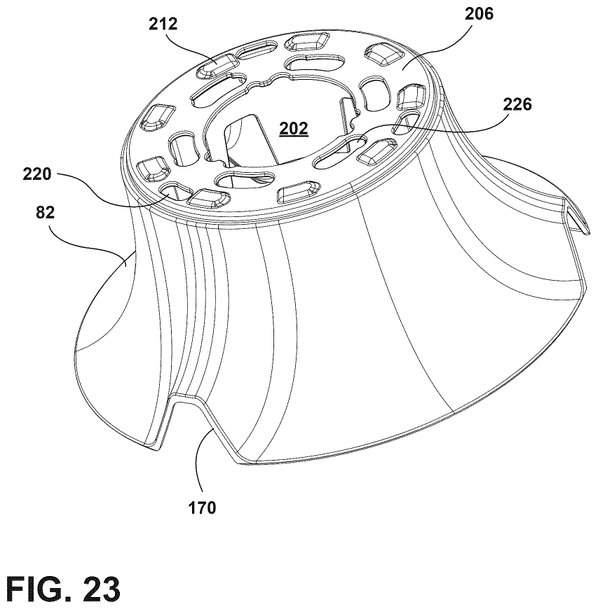

Referring to FIGS. 23-25, the basket assembly 30C also includes the skirt 82. As the basket assembly 30C is moved to position the connector 40 in the receiver 26, the skirt 82 is positioned on or over the impeller 24. The skirt 82 may rest on the impeller 24 or, alternatively, the skirt 82 may be spaced slightly from the impeller 24 with the basket assembly 30C supported by the engagement between the connector 40 and the receiver 26. The skirt 82 defines the channels 170, which are configured to be positioned over and receive the impeller fins 68. The skirt 82 also includes a guide wall 202 coupled to the skirt 82. The guide wall 202 extends on an inside of the skirt 82 and surrounds the connector 40. The guide wall 202 may define a shape that extends around engagement locations between the outer basket 38 and the connector 40, while providing space for the impeller fins 68. The guides 174 extend inwards towards the rotational axis 22 and the central receiver 26. The guides 174 may generally remain spaced from the central receiver 26; however, the guides 174 may abut the central receiver 26 without departing from the teachings herein.

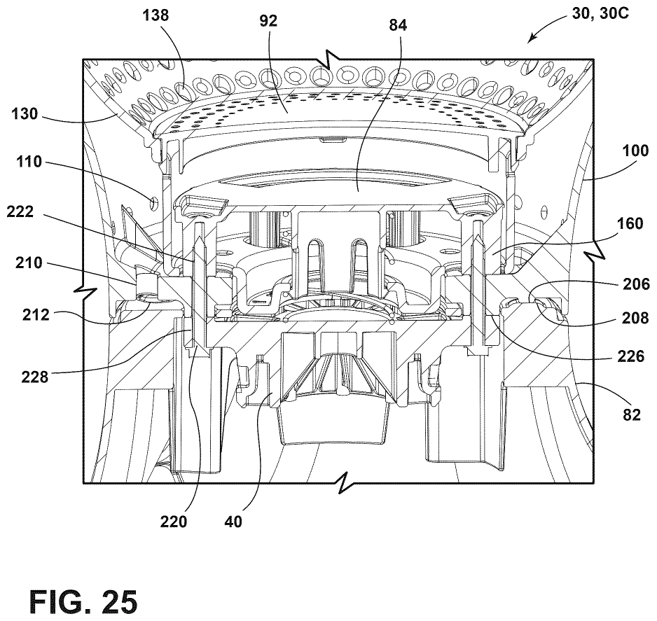

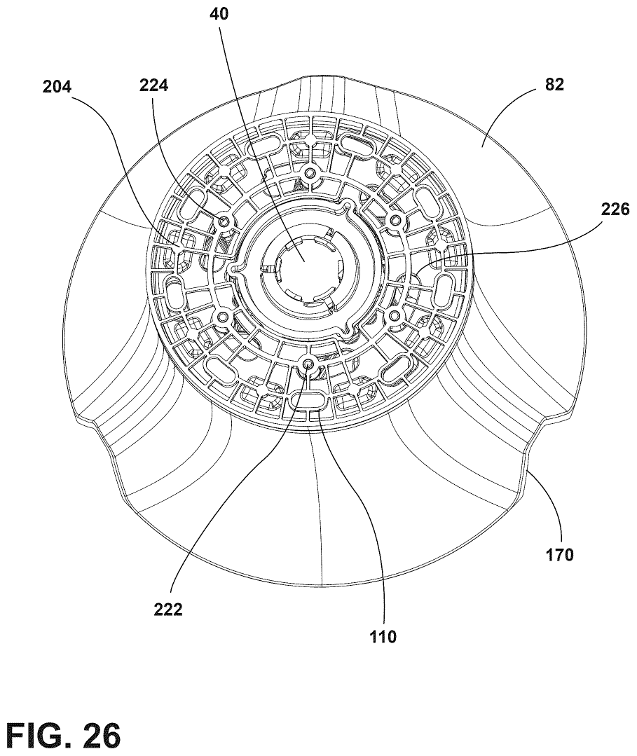

This configuration of the basket assembly 30C may have a different relationship between the outer basket 38 and the skirt 82. The bottom of the outer basket 38 is generally flat, having a grid structure 204 within the outer sidewall 100 extending beyond the grid structure 204. This grid structure 204 can be positioned on a top surface 206 of the skirt 82 and can be coupled with the connector 40 with the skirt 82 positioned therebetween, as illustrated in FIG. 25. The outer sidewall 100 may extend beyond the top surface 206 and along a side of the skirt 82, into a recessed rim 208 that extends along the perimeter of the top surface 206.

Additionally, the grid structure includes protrusions 210 arranged in a pattern with the outer fluid apertures 110 defined in the bottom of the outer basket 38. As illustrated, the protrusions 210 are circular knobs that alternate with the outer fluid apertures 110. The protrusions 210 are disposed adjacent to protruding regions 212 extending from the top surface 206 of the skirt 82. The protruding regions 212 may be wider than the protrusions 210 such that the protrusions 210 may move from one end of the respective protruding region 212 to the other as the baskets 36, 38 are rotated relative to the skirt 82. This may maintain the smaller gap between the bottom of the outer basket 38 and the skirt 82 at intervals around the perimeter of the basket assembly 30B. This relationship, along with the outer sidewall 100 extending beyond the top surface 206, reduces a gap or straight entry point between the outer basket 38 and the skirt 82. This more complex interface reduces items that can be caught between the basket 38 and the skirt 82 during the laundry cycle.

Referring still to FIGS. 23-25, the top surface 206 of the skirt 82 defines drain holes 220. The drain holes 220 are arranged along the perimeter of the top surface 206. When the baskets 36, 38 are rotated to the installed position, the outer fluid apertures 110 in the bottom of the outer basket 38 are aligned with the drain holes 220 to increase drainage from the basket assembly 30C. The fluid apertures 110, 138, and the drain holes 220 may allow small pieces of debris, food, dirt, etc. from the laundry items to drain from the interior compartment 38 of the basket assembly 30C.

Referring now to FIGS. 25 and 26, the basket assembly 30C includes the support guide 84 positioned within the lower housing 132 below the cap 92. The support guide 84 includes the peripheral posts 160, which may assist with guiding the movement of the inner basket 36. In this configuration, the peripheral posts 160 define inner channels for receiving coupling members 222. The coupling members 222 are coupled with the peripheral posts 160 and extend through the bottom of the outer basket 38. The outer basket 38 includes rimmed openings 224 through which the coupling members 222 extend.

The coupling members 222 also extend through guide holes 226 defined in the top surface of the skirt 82 to engage receivers 228 of the connector 40, which is disposed inside the skirt 82. The coupling members 222 and the connector 40 are configured to couple the baskets 36, 38 with the skirt 82. The guide holes 220 are arranged inside the drain holes 220 and on an opposing side of the guide wall 202. The receivers 228 are aligned with the guide holes 226 and arranged around the portion of the connector 40 that is inserted into the receiver 26, forming a peripheral flange that may not engage the impeller 24. The guide holes 226 are elongated, allowing the coupling members 222 to move between ends of the guide holes 226, respectively, as the baskets 36, 38 are moved between the insertion position and the installed position. The guide holes 226 define limits of the rotation of the baskets 36, 38 and provide a through-path for the coupling members 222 to maintain the engagement between the baskets 36, 38 and the skirt 82. The guide holes 226 may include features for retaining the coupling members 222 at the ends (e.g., fully in the insertion position or the installed position), such as detents or other similar features.

The rotation of the baskets 36, 38 relative to the skirt 82 allows the channels 170 to be smaller to reduce the gap 172 between the basket assembly 30B and the impeller fins 68. Further, the relationship between the outer basket 38 and the skirt 82 can reduce items from being pinched or caught therebetween. Further, the skirt 82 has a larger interface with the outer basket 38, which can improve control in rotating the baskets 36, 38. Additionally, the connection between the baskets 36, 38 and the skirt 82 is maintained by the coupling members 222 engaging the posts 160 inside the inner basket 36 and the connector 40 inside the skirt 82. Also, the guide holes 226 can guide and limit movement of the baskets 36, 38 for more convenient installation and removal.

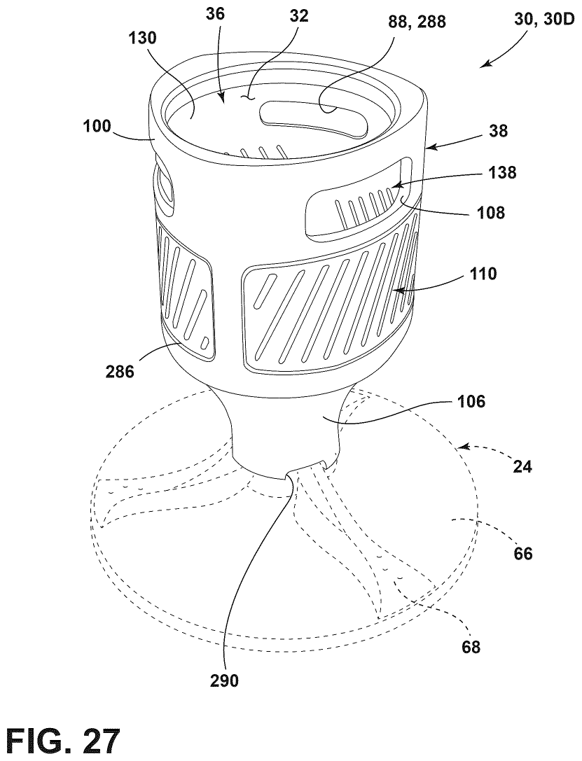

Referring to FIGS. 27-33, different configurations of the basket assembly 30D-30G are illustrated. Generally, the basket assembly 30 extends along a height of the drum 14. The size, including height and width, as well as the shape of the basket assembly 30 may differ based on the configuration of the laundry appliance 10, the size of the laundry appliance 10, the function of the basket assembly 30, etc. Typically, the basket assembly 30 may have a more rounded outer circumference to maximize capacity in both compartments 32, 34, have features to provide the agitation function, and reduce items getting caught between the basket assembly 30 and the drum 14. The exemplary configurations in FIGS. 27-33 may function and connect to the impeller 24 in a substantially similar manner as the basket assembly 30A, 30C, 30B described with respect to FIGS. 2-13G, FIGS. 14-19G, and FIGS. 20-26.

For example, as illustrated in FIG. 27, an additional or alternative configuration of the basket assembly 30D is illustrated, which may be a tall configuration extending a substantial height of the drum 14 (FIG. 2). The basket assembly 30D has a generally cylindrical shape for defining the inner compartment 32 and more sharply narrows to the neck 106 of the basket assembly 30D. The outer and inner fluid apertures 110, 138 are illustrated as diagonal openings, which align with one another to provide fluid communication between areas within and outside of the basket assembly 30D. The fluid apertures 110, 138 are illustrated in one or more recessed regions 286. The recessed regions 286 may provide some textural structure for agitating the laundry items and liquid around and/or within the basket assembly 30D.

Additionally, in this configuration, the handles 88 are configured as handle openings 288, which align with the outer openings 108 in the outer sidewall 100. The outer basket 38 may be integrally formed with the upper frame 80 or the upper frame 80 may be coupled to the basket assembly 30D. The handle openings 288 may generally align with the outer openings 108 in the outer sidewall 100. When the inner basket 36 is in the deployed position biased toward the impeller 24, top edges of the handle openings 288 may be lower than top edges of the outer openings 108 in the outer sidewall 100. The user may engage the top edges of the handle openings 288 and pull the handle openings 288 towards the top edges of the outer openings 108 in the outer sidewall 100 to provide sufficient movement to move the inner basket 36 to the retracted position. The user may grip around the upper frame 80 or top edge 102 of the outer basket 38 and squeeze, which may move the handle openings 288 and, consequently, the inner basket 36 upwards toward the retracted position.

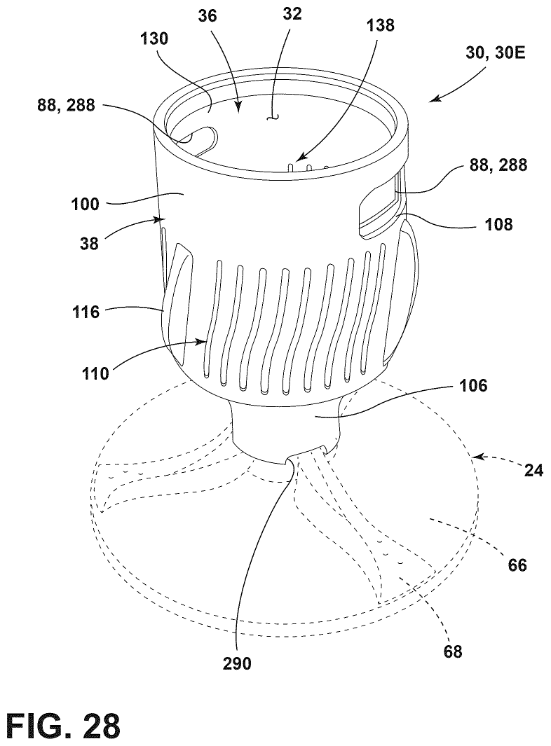

As illustrated in FIG. 28, a mid-size or mid-height configuration of the basket assembly 30E is illustrated, which is substantially similar to the configuration illustrated in FIG. 26 with a shorter overall height. A shorter height may be beneficial for a smaller laundry appliance 10 (FIG. 1) or for retaining a larger outer compartment 34. In this configuration, the outer and inner fluid apertures 110, 138 are illustrated as curved and/or diagonal elongated openings. The outer basket 38 includes the agitation fins 116 extending outwardly therefrom between sets of outer fluid apertures 110 to provide the agitation function for the items in the outer compartment 34.

Referring to FIG. 2229 a short configuration of the basket assembly 30F is illustrated. In this configuration, the neck 106 of the basket assembly 30F may be omitted, and the outer basket 38 may have a generally consistent width or diameter from the top to the bottom of the outer basket 38. The bottom of the outer sidewall 100 may be disposed proximate to or abut the impeller 24. The bottom of the outer basket 38 may define channels 290, similar to the skirt 82 (see FIGS. 11, 12, 14, 15, 24) for receiving the impeller fins 68 and allowing rotation relative to the impeller fins 68.

The outer and inner fluid apertures 110, 138 are illustrated as horizontally extending outer openings 108 in recessed regions 286. The recessed regions 286 may assist with the agitation function. Additionally, the inner basket 36 may have the handle openings 288, which may have a rim 292 that protrudes outward. The rim may extend toward or through the outer openings 108 in the outer sidewall 100. The rim 292 may assist with locating the handle openings 288 and providing a grasping location for the user.

In this configuration, the assembly basket assembly 30F includes a lid 294, which may be coupled to the top of the basket assembly 30F. The lid 294 may be advantageous for smaller or shorter basket assemblies 30F to maintain the separation between the inner compartment 32 and the outer compartment 34, particularly when items in the outer compartment 34 may extend higher than or over the basket assembly 30D. The lid 294 may substantially or entirely cover the inner compartment 32. The lid 294 may have fluid apertures 296 allowing fluid flow therethrough. Additionally, the lid 294 may have fins 298 to provide increased agitation function for the laundry items in the outer compartment 34 that may surround or be disposed over the basket assembly 30F. The lid may 294 may also include a handle 88 to assist with positioning the lid 294 on the basket assembly 30F and removing the lid 294 from the basket assembly 30D.

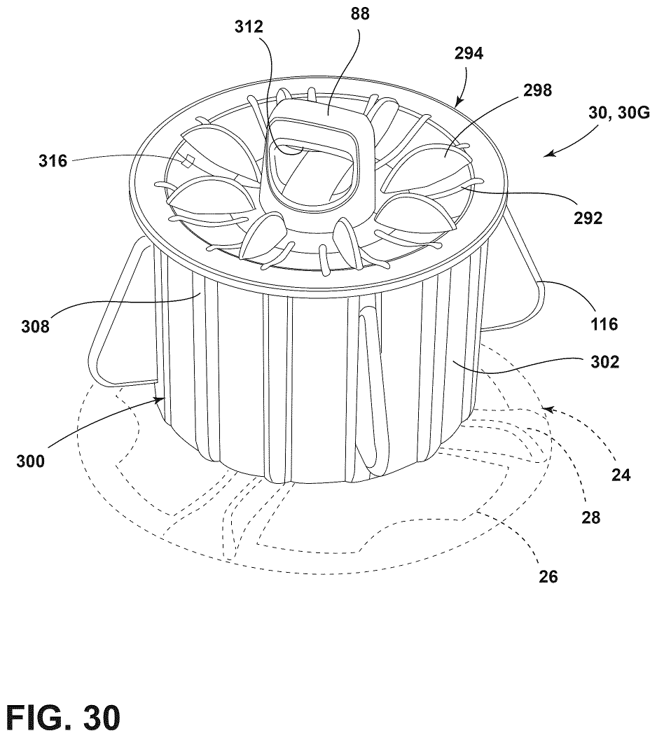

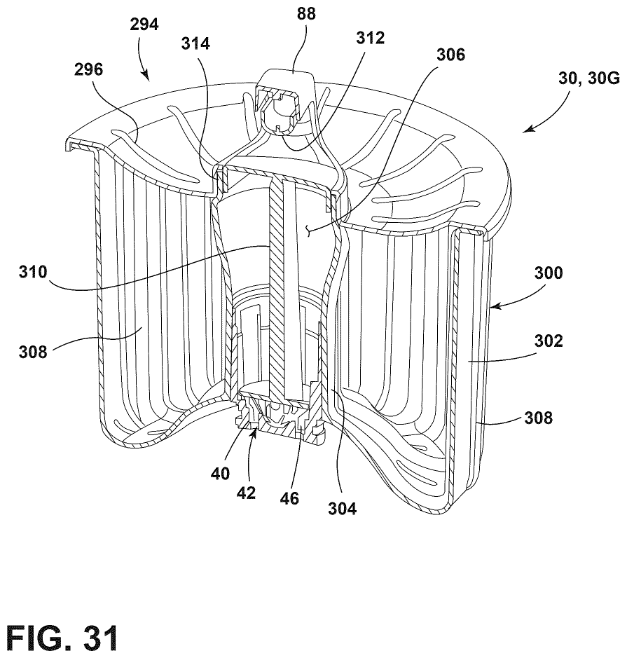

Referring to FIGS. 30 and 31, an additional or alternative configuration of the basket assembly 30G is illustrated, which includes a single basket 300 with the connector 40 and the handle 88 being separate from the basket 300. The basket 300 includes an outer wall 302 and an inner wall 304 defining a receiving channel 306. The basket 300 is generally a cylindrical shape with a ring-shaped inner compartment 32 that encircles the receiving channel 306. The basket 300 generally includes ribs 308 that extend along the inner wall 304 and/or the outer wall 302 to provide the agitation function to items in the inner compartment 32 and/or the outer compartment 34 as the basket 300 rotates during the laundry cycle.

The basket assembly 30G includes a locking post 310, which includes at least the connector 40 and the locking feature 44 and which extends through the receiving channel to engage the impeller 24. The handle 88 is coupled to the locking post 310. Typically, the handle 88 includes a movable grip portion 312 that can be squeezed or pulled to move the locking post 310 and, consequently, the locking feature 44 to the retracted position. The locking post 310 may be inserted and rotated to install the basket assembly 30E, similar to the basket assembly 30A described with respect to FIGS. 2-13G, the basket assembly 30B described with respect to FIGS. 14-19G, and the basket assembly 30C described with respect to FIGS. 20-26. The handle 88 is positioned over the top of the locking post 310 and engages a rim 314 of the inner wall 304 along the receiving channel 306 to couple with the basket 300. This engagement between the handle 88 and the rim 314 can reduce or prevent items from the outer compartment 34 from entering the receiving channel 306 during the laundry cycle and may also provide an additional connection between the basket 300 and the locking post 310 for rotating the basket 300 with the impeller 24.

The basket assembly 30G may be utilized with the lid 294 to more fully separate the inner compartment 32 from the outer compartment 34. The lid 294 may be formed of one integrated piece or multiple portions that extend around the handle 88. When the lid 294 is constructed of multiple portions, the portions include mating locking or latching features 316 to couple the portions of the lid 294 together. The multi-portion configuration of the lid 294 may assist with closely fitting the lid 294 around the handle 88 to reduce or prevent items from entering the inner compartment 32 during the laundry cycle. In certain aspects, the lid 294 may define the fluid apertures 296 for allowing wash liquids to flow into and out of the inner compartment 32 during the laundry cycle. The lid 294 may also include fins 298 which extend upwardly therefrom and may contribute to the agitation function of the basket assembly 30G for items in the outer compartment 34.

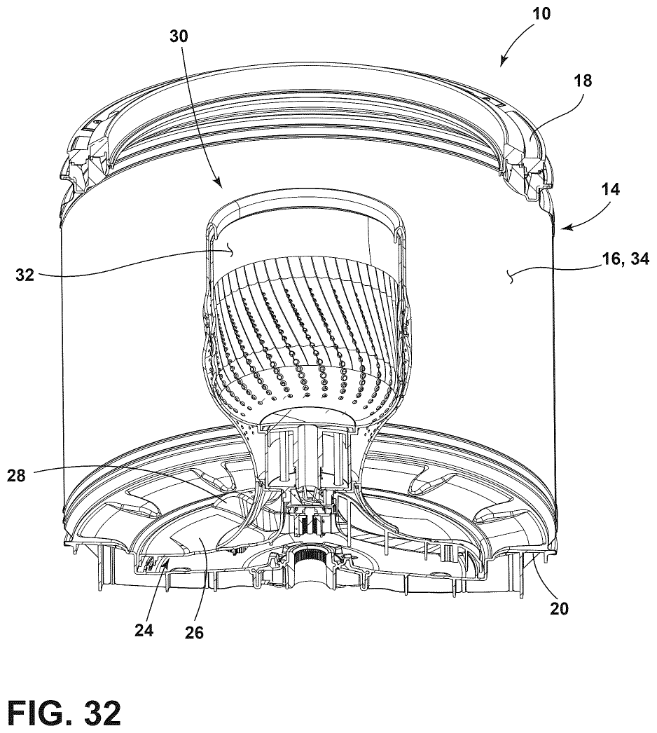

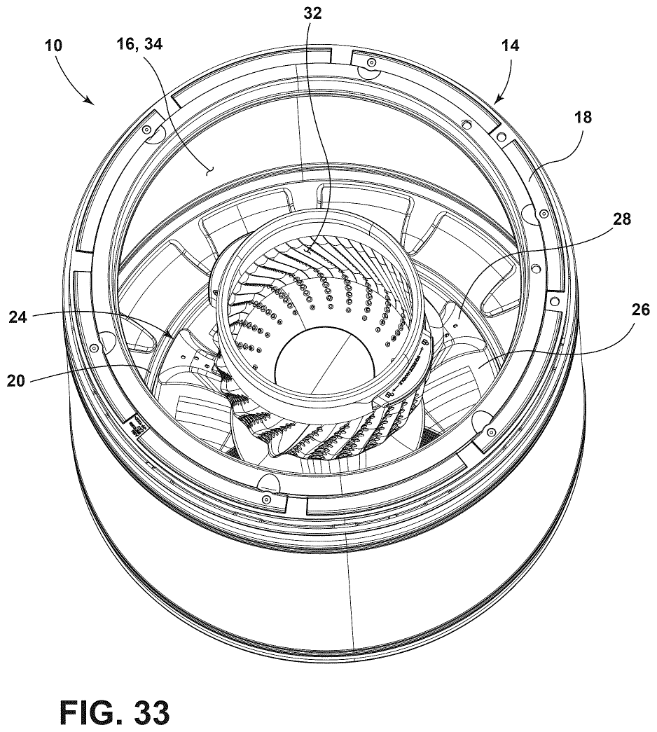

Referring to FIGS. 32 and 33, as well as FIGS. 1-33, while various configurations are illustrated, it is contemplated that these configurations are exemplary. Accordingly, features or components described with respect to the illustrated configurations may be utilized with other configurations of the basket assembly 30 without departing from the teachings herein. For example, each basket assembly 30 may be used with or without any configuration of the lid 294. The basket assemblies 30 may be used with or without the skirt 82. The basket assemblies 30 may include the skirt 82 and may rotate with or separate from the skirt 82. Further, each basket assembly 30 may be used with the protruding handles 88 or the handle openings 288 with or without the rim 292.

Each of the configurations of the basket assembly 30 described herein may be inserted into the drum 14 and selectively coupled with the impeller 24 for providing two physically separate compartments 32, 34 within the drum 14. The two compartments 32, 34 may be physically separated, while allowing fluid communication between the two compartments 32, 34 to utilize the same wash liquid (water, chemistries, etc.). In this way, the same wash liquid may be utilized for both the inner compartment 32 and the outer compartment 34 with the liquid flowing into and out of the basket assembly 30 through the outer and inner fluid apertures 110, 138.

The level of liquid in the outer compartment 34 generally matches the level of liquid in the inner compartment 32. Accordingly, as the drum 14 fills with liquid for the laundry cycle, the liquid levels may rise concurrently in the inner and outer compartments 32, 34. Upon completion of the wash cycle, the liquid may concurrently drain from the outer compartment 34 and the inner compartment 32. The liquid may drain from the basket assembly 30 via the fluid apertures 110, 138. Additionally, the bottom of the basket assembly 30 may define drain holes and/or the skirt 82 may define drain holes 220 for further draining liquid from the basket assembly 30.

The multiple engagements between the basket assembly 30 and the impeller 24 (e.g., the protrusions 28 in the slots 42 and the protrusions 28 with the projections 46) may assist with retaining the engagement between the basket assembly 30 and the impeller 24 during the laundry cycle. The basket assembly 30 is configured to balance and maximize capacity in both the inner compartment 32 and the outer compartment 34. The impeller 24 and, consequently, the basket assembly 30 are rotated about the rotational axis 22 by the drive system during the laundry cycle. The rotating basket assembly 30 may provide the agitation function in one or both of the inner and outer compartments 32, 34. The ridges 112, 140 and grooves 114, 142, agitation fins 116, 298, and/or ribs 308 can provoke load movement to assist in providing the agitation function for the laundry items and may also provoke liquid agitation to assist with the wash cycle.

The basket assembly 30 may also be removed from the drum 14 to be interchanged with other accessories 70 and/or for the laundry appliance 10 utilized without the accessories 70. The basket assembly 30 being removable from the laundry appliance 10 may provide a storage space for laundry items prior to the laundry cycle. In this aspect, the user may utilize the basket assembly 30 as a hamper or for other storage of laundry items. The user may install the basket assembly 30 with items in the inner compartment 32 and/or may load items into the inner compartment 32 after installation. When the lid 294 is utilized, the lid 294 may be positioned over the basket assembly 30 and coupled to one or both baskets 36, 38 before the start of the laundry cycle.

Use of the present device may provide for a variety of advantages. For example, the removable basket assembly 30 may be coupled to the impeller 24 to physically separate and provide multiple compartments 32, 34 within the drum 14 for simultaneously or concurrently washing two sets of items. Additionally, the basket assembly 30 may be removed from the laundry appliance 10 to allow for other appliance accessories 70 or to increase capacity size of the drum 14 without the use of the accessories 70. Also, the removal of the basket assembly 30 may allow the use of the basket assembly 30 for storage or as a hamper.

Further, the basket assembly 30 may utilize connecting components on the inner and outer baskets 36, 38 that each engage the impeller 24 to provide multiple points of engagement and multiple steps for installing and the basket assembly 30. The multiple engagement points may assist with retaining the engagement with the impeller 24 during rotation. Moreover, the biasing member 48 may bias the inner basket 36 and, consequently, the locking feature 44 to the deployed position to lock the basket assembly 30 to the impeller 24. The basket assembly 30 may also provide the agitation function for one or both of the inner compartment 32 and the outer compartment 34. The basket assembly 30 may also include the attached skirt 82 where the baskets 36, 38 can rotate relative to the skirt 82 to reduce the gap 172 with the impeller fins 68 and guide rotation between the insertion and installed positions. The baskets 36, 38 may have different engagements with the skirt 82 to guide rotation of the baskets 36, 28. Additionally, the basket assembly 30 may maximize the capacity both in the inner compartment 32 in the basket assembly 30 and outer compartment 34 surrounding the basket assembly 30. Additional benefits or advantages may be realized and/or achieved.

The device disclosed herein is further summarized in the following paragraphs and is further characterized by combinations of any and all various aspects described herein.

According to another aspect of the present disclosure, a laundry appliance includes a cabinet and a drum disposed within the cabinet. The drum defines an interior. The drum has a drum opening opposite a closed end along a rotational axis. An impeller is operably coupled with the closed end of the drum. The impeller includes a receiver and protrusions proximate to the receiver. A basket assembly is selectively couplable with the impeller to separate the interior of the drum into an outer compartment between the drum and the basket assembly and an inner compartment within the basket assembly. The basket assembly includes an outer basket and an inner basket disposed within the outer basket. The inner basket is movable within the outer basket along the rotational axis. The basket assembly includes a connector configured to be positioned in the receiver. The connector includes slots configured to receive the protrusions. The basket assembly also includes a locking feature operably coupled with the connector. The locking feature includes projections operable between a retracted position and a deployed position. A biasing member is configured to bias the locking feature in the deployed position to lock the protrusions in the slots and, consequently, lock the basket assembly to the impeller.

According to another aspect of the present disclosure, slots include an insertion portion and a locking portion. A basket assembly is configured to be moved toward an impeller to move the protrusions along the insertion portions and rotated to move the protrusions along the locking portions.

According to another aspect of the present disclosure, an inner basket includes handles, and movement of the handles causes movement of locking features against a biasing force of a biasing member to adjust projections to a retracted position.

According to another aspect of the present disclosure, an outer basket defines openings aligned with handles of an inner basket.

According to another aspect of the present disclosure, handles extend outwardly from a sidewall of an inner basket and through openings.

According to another aspect of the present disclosure, an outer basket defines first fluid apertures in a sidewall and an inner basket defines second fluid apertures in a sidewall. The first fluid apertures and the second fluid apertures align to allow fluid flow between an outer compartment and an inner compartment.

According to another aspect of the present disclosure, an outer basket includes agitation fins extending outwardly from a sidewall.

According to another aspect of the present disclosure, a basket assembly includes a skirt coupled to an outer basket. The skirt is configured to be positioned over an impeller.

According to another aspect of the present disclosure, an impeller includes impeller fins, and a skirt includes channels to receive the impeller fins.

According to another aspect of the present disclosure, a basket assembly includes a cover configured to couple to a top of the basket assembly to further separate an inner compartment from an outer compartment.

According to another aspect of the present disclosure, an inner basket includes ridges and grooves on an inner surface thereof.

According to another aspect, a laundry appliance includes a drum defining an interior. The drum has a drum opening opposite a closed end along a rotational axis. An impeller is operably coupled with the closed end of the drum. The impeller includes a receiver and protrusions proximate to the receiver. A basket assembly is selectively couplable with the impeller. The basket assembly includes an outer basket including a sidewall and agitation fins extending outwardly from the sidewall. The sidewall defines openings. The basket assembly includes an inner basket that is disposed within the outer basket. The inner basket is movable within the outer basket along the rotational axis. The inner basket includes handles aligned with the openings. The basket assembly also includes a connector configured to be positioned in the receiver to couple the basket assembly with the impeller and a locking feature operably coupled with the connector. The locking feature is operable between a retracted position and a deployed position. A biasing member is configured to bias the locking feature toward the deployed position to lock the basket assembly to the impeller. A force applied to the handles of the inner basket is configured to move the locking feature to the retracted position to disengage the basket assembly from the impeller.

According to another aspect of the present disclosure, a basket assembly includes a skirt coupled to an outer basket. The skirt includes channels configured to receive impeller fins of an impeller.

According to another aspect of the present disclosure, a connector includes slots each with an insertion portion and a locking portion. An impeller includes protrusions. A basket assembly is configured to be moved toward the impeller to move the protrusions along the insertion portions and rotated to move the protrusions along the locking portions. An outer basket and an inner basket are configured to rotate separately from the skirt.

According to another aspect of the present disclosure, a top of an outer basket is wider than a bottom of the outer basket.

According to yet another aspect, a basket assembly for a laundry appliance includes an outer basket with an outer sidewall defining at least one opening proximate to a top of the outer basket, first fluid apertures arranged along a height of the outer sidewall, and a connector at a bottom of the outer basket. The connector is configured to engage an impeller of the laundry appliance. An inner basket disposed within the outer basket and is movable between the top and the bottom of the outer basket. The inner basket includes an inner sidewall defining second fluid apertures that align with the first fluid apertures to provide fluid communication between an area outside the outer basket and an area inside the inner basket. At least one handle is aligned with the at least one opening of the outer basket. A locking feature extends from the bottom of the inner basket. The inner basket is biased toward a deployed position with projections extending through the connector to engage the impeller. The inner basket is configured to be adjusted to a retracted position in response to a force applied to the at least one handle to disengage the projections from the impeller.

According to another aspect of the present disclosure, a biasing member is disposed between a connector and an inner basket.

According to another aspect of the present disclosure, at least one opening includes first and second openings. At least one handle includes first and second handles extending through the first and second openings.

According to another aspect of the present disclosure, an outer basket includes agitation fins extending outwardly from an outer sidewall. An inner basket includes ridges and grooves along an inner surface of an inner sidewall.

According to another aspect of the present disclosure, a skirt coupled to a bottom of an outer basket and extending around a connector.

According to another aspect of the present disclosure, a laundry appliance includes a cabinet and a drum disposed within the cabinet and defining an interior. The drum has a drum opening opposite a closed end along a rotational axis. An impeller is operably coupled with the closed end of the drum. The impeller includes a receiver. A basket assembly is selectively couplable with the impeller to separate the interior of the drum into an outer compartment between the drum and the basket assembly and an inner compartment within the basket assembly. The basket assembly includes an outer basket and an inner basket disposed within the outer basket. The inner basket is movable within the outer basket along the rotational axis. A connector is configured to be positioned in the receiver. A locking feature is operably coupled with the connector and configured to adjust between a retracted position and a deployed position engaging the impeller. A skirt is coupled to the outer basket and is configured to be positioned over the impeller. The outer basket and the inner basket are configured to rotate about the rotational axis and relative to the skirt.

According to another aspect of a present disclosure, a basket assembly includes an engagement bracket coupled to a connector. The engagement bracket includes tabs extending outwardly relative to a rotational axis. The tabs are configured to engage a skirt.

According to another aspect of a present disclosure, a skirt includes extensions proximate to a top edge thereof. Tabs are configured to slidably engage the extensions to guide rotation of an outer basket relative to the skirt.

According to another aspect of a present disclosure, a skirt includes stoppers proximate to proximal ends of extensions. Tabs are configured to abut stoppers when an outer basket is fully rotated to an initial insertion position.

According to another aspect of a present disclosure, each extension includes a detent proximate to a distal end thereof. Tabs are configured to be positioned in the detents when an outer basket is fully rotated to an installed position.

According to another aspect of a present disclosure, an impeller includes protrusions proximate to a receiver. A connector includes slots configured to receive the protrusions.

According to another aspect of a present disclosure, slots include an insertion portion and a locking portion. A basket assembly is configured to be moved toward an impeller to move protrusions along the insertion portions and rotated to move the protrusions along the locking portions and tabs along extensions to detents.

According to another aspect of a present disclosure, a locking feature includes projections configured to adjust between retracted and deployed positions. The projections are configured to adjust to the deployed position when tabs are in detents.

According to another aspect of a present disclosure, a skirt defines channels to receive fins of an impeller.

According to another aspect of a present disclosure, a skirt includes guides extending toward a rotational axis. The guides are disposed between adjacent channels.

According to another aspect of a present disclosure, a laundry appliance includes a drum defining an interior. The drum has a drum opening opposite a closed end along a rotational axis. An impeller is operably coupled with the closed end of the drum. The impeller includes a receiver and protrusions proximate to the receiver. A basket assembly is selectively couplable with the impeller. The basket assembly includes an outer basket and an inner basket disposed within the outer basket. The inner basket is movable within the outer basket along the rotational axis. A connector is configured to be positioned in the receiver to couple the basket assembly with the impeller. A locking feature is operably coupled with the connector and operable between a retracted position and a deployed position. The deployed position is configured to lock the basket assembly to the impeller. An engagement bracket is coupled to the connector. The engagement bracket includes tabs extending outwardly relative to the rotational axis. A skirt is coupled to the outer basket and includes flexible extensions proximate to the engagement bracket. Each flexible extension includes a detent at a distal end thereof. The tabs are configured to slidably engage the flexible extensions as the outer basket and inner basket are rotated relative to the skirt and about the rotational axis between an initial insertion position and an installed position.

According to another aspect of a present disclosure, a basket assembly includes handles coupled to an inner basket and a biasing member configured to bias a locking feature toward a deployed position to lock the basket assembly to an impeller. A force applied to the handles of the inner basket is configured to move the locking feature to a retracted position to disengage the basket assembly from the impeller.

According to another aspect of a present disclosure, tabs are disposed in detents when an inner basket and an outer basket are in an installed position.

According to another aspect of a present disclosure, a locking feature is configured to adjust a deployed position when tabs are in detents in an installed position.

According to another aspect of a present disclosure, a skirt includes stoppers proximate to proximal ends of flexible extensions. Tabs are configured to abut the stoppers when an inner basket and an outer basket are in an initial insertion position.

According to another aspect of a present disclosure, slots include an insertion portion and a locking portion. A basket assembly is configured to be moved toward an impeller to move protrusions along the insertion portions and rotated to move the protrusions along the locking portions and tabs along flexible extensions to detents to an installed position.

According to another aspect of a present disclosure, a skirt includes channels configured to receive fins of an impeller and inwardly extending guides disposed between adjacent channels.

According to another aspect of a present disclosure, a basket assembly for a laundry appliance includes an outer basket and an inner basket disposed within the outer basket. The inner basket is movable within the outer basket along a rotational axis. A connector is configured to be positioned in an impeller receiver. The connector includes slots configured to receive protrusions of an impeller to couple the basket assembly with the impeller. A locking feature is operably coupled with the connector. The locking feature includes projections operable between a retracted position and a deployed position to lock the inner and outer baskets to the impeller. An engagement bracket is coupled to the connector. The engagement bracket includes tabs extending outwardly therefrom. A skirt is coupled to the outer basket and includes extensions proximate to the engagement bracket. The tabs are configured to slidably engage the extensions as the inner and outer baskets rotate relative to the skirt and about the rotational axis.

According to another aspect of a present disclosure, an inner basket and an outer basket rotate separately from a skirt between an initial insertion position where tabs abut stoppers of the skirt and an installed position where the tabs are disposed in detents at distal ends of extensions.

According to another aspect of a present disclosure, a skirt extends from a bottom of an outer basket and is configured to extend over an impeller. The skirt defines channels to receive fins of the impeller.

According to another aspect of the present disclosure, a support member is disposed in a lower housing of an inner basket and includes peripheral posts. Coupling members are coupled to the peripheral posts and extend through an outer basket to engage a connector on an opposing side of a top surface of a skirt. The top surface defines guide holes for defining rotation of the outer basket and the inner basket relative to the skirt.

According to another aspect of the present disclosure, a top surface of a skirt defines drain holes configured to align with outer fluid apertures defined at a bottom of an outer basket.

According to another aspect of the present disclosure, a laundry appliance includes a drum defining an interior. The drum has a drum opening opposite a closed end along a rotational axis. An impeller is operably coupled with the closed end of the drum. The impeller includes a receiver and protrusions proximate to the receiver. A basket assembly selectively couplable with the impeller. The basket assembly includes an outer basket and an inner basket disposed within the outer basket. The inner basket is movable within the outer basket along the rotational axis. A connector is configured to be positioned in the receiver to couple the basket assembly with the impeller. A locking feature is operably coupled with the connector and operable between a retracted position and a deployed position. The deployed position is configured to lock the basket assembly to the impeller. A support member is disposed within the inner basket. Coupling members extend from the support member. A skirt is coupled to the outer basket and defines guide holes. The coupling members extend through the outer basket and through the guide holes of the skirt to engage the connector. The guide holes guide rotation of the outer basket and the inner basket as the outer basket and inner basket are rotated relative to the skirt and about the rotational axis between an initial insertion position and an installed position.

According to another aspect of the present disclosure, a skirt defines drain holes in a top surface thereof.

According to another aspect of the present disclosure, an outer basket includes an outer sidewall including a neck. The outer basket defines outer fluid apertures on the neck and a bottom of the outer sidewall. According to another aspect of the present disclosure, an inner basket includes an inner sidewall having a portion that narrows toward a bottom thereof. The inner basket defines inner guide apertures on the portion that narrows.

According to another aspect of the present disclosure, a connector includes slots with an insertion portion and a locking portion. A basket assembly is configured to be moved toward an impeller to move protrusions along the insertion portions and rotated to move the protrusions along the locking portions.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A laundry appliance, comprising:
a cabinet;
a drum disposed within the cabinet and defining an interior, wherein the drum has a drum opening opposite a closed end along a rotational axis;
an impeller operably coupled with the closed end of the drum, wherein the impeller includes a receiver; and
a basket assembly selectively couplable with the impeller to separate the interior of the drum into an outer compartment between the drum and the basket assembly and an inner compartment within the basket assembly, wherein the basket assembly includes:
an outer basket;
an inner basket disposed within the outer basket, wherein the inner basket is movable within the outer basket along the rotational axis;
a connector configured to be positioned in the receiver;
a locking feature operably coupled with the connector and configured to adjust between a retracted position and a deployed position engaging the impeller; and
a skirt coupled to the outer basket and configured to be positioned over the impeller, wherein the outer basket and the inner basket are configured to rotate about the rotational axis and relative to the skirt.

2. The laundry appliance of claim 1, wherein the basket assembly includes an engagement bracket coupled to the connector, wherein the engagement bracket includes tabs extending outwardly relative to the rotational axis, and wherein the tabs are configured to engage the skirt.

3. The laundry appliance of claim 2, wherein the skirt includes extensions proximate to a top edge thereof, wherein the tabs are configured to slidably engage the extensions to guide rotation of the outer basket and the inner basket relative to the skirt.

4. The laundry appliance of claim 3, wherein the skirt includes stoppers proximate to proximal ends of the extensions, and wherein the tabs are configured to abut the stoppers when the outer basket is fully rotated to an initial insertion position.

5. The laundry appliance of claim 3, wherein each extension includes a detent proximate to a distal end thereof, and wherein the tabs are configured to be positioned in the detents when the outer basket is fully rotated to an installed position.

6. The laundry appliance of claim 5, wherein the impeller includes protrusions proximate to the receiver, and wherein the connector includes slots configured to receive the protrusions.

7. The laundry appliance of claim 6, wherein the slots include an insertion portion and a locking portion, and wherein the basket assembly is configured to be moved toward the impeller to move the protrusions along the insertion portions and rotated to move the protrusions along the locking portions and the tabs along the extensions to the detents.

8. The laundry appliance of claim 5, wherein the locking feature includes projections configured to adjust between the retracted and deployed positions, and wherein the projections are configured to adjust to the deployed position when the tabs are in the detents.

9. The laundry appliance of claim 1, further comprising:
a support member disposed in a lower housing of the inner basket, the support member having peripheral posts; and
coupling members coupled to the peripheral posts and extending through the outer basket to engage the connector on an opposing side of a top surface of the skirt, wherein the top surface defines guide holes for defining rotation of the outer basket and the inner basket relative to the skirt.

10. The laundry appliance of claim 9, wherein the top surface of the skirt defines drain holes configured to align with outer fluid apertures defined at a bottom of the outer basket.

11. A laundry appliance, comprising:
a drum defining an interior, wherein the drum has a drum opening opposite a closed end along a rotational axis;
an impeller operably coupled with the closed end of the drum, wherein the impeller includes a receiver and protrusions proximate to the receiver; and
a basket assembly selectively couplable with the impeller, wherein the basket assembly includes:
an outer basket;
an inner basket disposed within the outer basket, wherein the inner basket is movable within the outer basket along the rotational axis;
a connector configured to be positioned in the receiver to couple the basket assembly with the impeller;
a locking feature operably coupled with the connector and operable between a retracted position and a deployed position, the deployed position configured to lock the basket assembly to the impeller; a support member disposed within the inner basket;
coupling members extending from the support member; and
a skirt coupled to the outer basket and defining guide holes, wherein the coupling members extend through the outer basket and through the guide holes of the skirt to engage the connector, the guide holes guiding rotation of the outer basket and the inner basket as the outer basket and inner basket are rotated relative to the skirt and about the rotational axis between an initial insertion position and an installed position.

12. The laundry appliance of claim 11, wherein the basket assembly includes:
handles coupled to the inner basket; and
a biasing member configured to bias the locking feature toward the deployed position to lock the basket assembly to the impeller, and wherein a force applied to the handles of the inner basket is configured to move the locking feature to the retracted position to disengage the basket assembly from the impeller.

13. The laundry appliance of claim 11, wherein the skirt defines drain holes in a top surface thereof.

14. The laundry appliance of claim 11, wherein the outer basket includes an outer sidewall including a neck, and wherein the outer basket defines outer fluid apertures on the neck and a bottom of the outer sidewall.

15. The laundry appliance of claim 11, wherein the inner basket includes an inner sidewall having a portion that narrows toward a bottom thereof, and wherein the inner basket defines inner guide apertures on the portion that narrows.

16. The laundry appliance of claim 11, wherein the connector includes slots with an insertion portion and a locking portion, and wherein the basket assembly is configured to be moved toward the impeller to move the protrusions along the insertion portions and rotated to move the protrusions along the locking portions.

17. The laundry appliance of claim 11, wherein the skirt includes channels configured to receive fins of the impeller and inwardly extending guides disposed between adjacent channels.

18. A basket assembly for a laundry appliance, comprising:
an outer basket;
an inner basket disposed within the outer basket, wherein the inner basket is movable within the outer basket along a rotational axis;
a connector configured to be positioned in an impeller receiver, wherein the connector includes slots configured to receive protrusions of an impeller to couple the basket assembly with the impeller;
a locking feature operably coupled with the connector, wherein the locking feature includes projections operable between a retracted position and a deployed position to lock the inner and outer baskets to the impeller;
an engagement bracket coupled to the connector, wherein the engagement bracket includes tabs extending outwardly therefrom; and
a skirt coupled to the outer basket and including extensions proximate to the engagement bracket, wherein the tabs are configured to slidably engage the extensions as the inner and outer baskets rotate relative to the skirt and about the rotational axis.

19. The basket assembly of claim 18, wherein the inner basket and the outer basket rotate separately from the skirt between an initial insertion position where the tabs abut stoppers of the skirt and an installed position where the tabs are disposed in detents at distal ends of the extensions.

20. The basket assembly of claim 18, wherein the skirt extends from a bottom of the outer basket and is configured to extend over the impeller, and wherein the skirt defines channels to receive fins of the impeller.
